(19) United States
(12) Patent Application Publication
(10) Pub. No.: US 2026/0142952 A1
(43) Pub. Date: May 21, 2026

(54) METHOD, DEVICE, SERVER, AND NON-TRANSITORY COMPUTER-READABLE RECORDING MEDIUM FOR REMOTE MONITORING OF BIOSIGNALS

(71) Applicant: HUINNO, CO., LTD., Seoul (KR)

(72) Inventors: Sung Hoon JUNG, Seoul (KR); Yeong Joon GIL, Busan (KR)

(21) Appl. No.: 19/391,019

(22) Filed: Nov. 17, 2025

Related U.S. Application Data
(63) Continuation of application No. PCT/KR2023/016291, filed on Oct. 19, 2023.

(30) Foreign Application Priority Data
May 19, 2023 (KR) 10-2023-0064973

(51) Int. Cl. H04L 9/40; H04L 9/30

(52) U.S. Cl. CPC H04L 63/0435; H04L 9/30

(57) ABSTRACT

A method for remote monitoring of biosignals includes transmitting unique information of a first biosignal measurement device to a server; receiving an activation command for at least a part of functions of the first biosignal measurement device, in response to matching between the unique information of the first biosignal measurement device and unique information of a first subject received from the server; and generating a symmetric key for the first biosignal measurement device on the basis of a public key generated by the first biosignal measurement device and a public key generated by the server, and encrypting biosignal data measured by the first biosignal measurement device using the generated symmetric key.

### CROSS-REFERENCE TO RELATED APPLICATIONS

This application is a Continuation of International Application No. PCT/KR2023/016291 filed on Oct. 19, 2023, which claims priority from Korean Patent Application No. 10-2023-0064973 filed on May 19, 2023. The aforementioned applications are incorporated herein by reference in their entireties.

### TECHNICAL FIELD

The present invention relates to a method, device, server, and non-transitory computer-readable recording medium for remote monitoring of biosignals.

### RELATED ART

Recently, wearable devices for continuous monitoring of biosignal data have been widely used in the healthcare field. These wearable devices can be used to remotely monitor health condition of patients within medical institutions such as hospitals, or to remotely monitor health condition of users in their daily lives outside medical institutions.

In order to remotely monitor biosignals, a biosignal measurement device constantly attached to a subject's body to measure and store his/her biosignals is required. In addition, a wired or wireless communication interface, a server provided with a biosignal analysis model, a device for providing monitoring information to medical personnel, a device for controlling or setting the biosignal measurement device, and the like are further required, and a system that organically combines them should be established.

The inventor(s) present a novel and inventive system capable of remotely monitoring a subject's health condition by continuously measuring biosignals of the subject in response to various environments.

### SUMMARY

One object of the present invention is to provide a system capable of remotely monitoring a subject's health condition by continuously measuring biosignals of the subject in response to various environments.

The representative configurations of the invention to achieve the above object are described below.

According to one aspect of the invention, there is provided a method for remote monitoring of biosignals, the method comprising the steps of: transmitting unique information of a first biosignal measurement device to a server; receiving an activation command for at least a part of functions of the first biosignal measurement device, in response to matching between the unique information of the first biosignal measurement device and unique information of a first subject received from the server; and generating a symmetric key for the first biosignal measurement device on the basis of a public key generated by the first biosignal measurement device and a public key generated by the server, and encrypting biosignal data measured by the first biosignal measurement device using the generated symmetric key.

According to another aspect of the invention, there is provided a method for remote monitoring of biosignals, the method comprising the steps of: transmitting unique information of a first subject to a first biosignal measurement device; receiving information on matching between unique information of the first biosignal measurement device and the unique information of the first subject; and generating a symmetric key for the first biosignal measurement device on the basis of a public key generated by the first biosignal measurement device and a public key generated by the server, and decrypting biosignal data received from the first biosignal measurement device using the generated symmetric key.

According to another aspect of the invention, there is provided a device for remote monitoring of biosignals, the device comprising: a communication unit configured to transmit unique information of a first biosignal measurement device to a server, and receive an activation command for at least a part of functions of the first biosignal measurement device, in response to matching between the unique information of the first biosignal measurement device and unique information of a first subject received from the server; and a control unit configured to generate a symmetric key for the first biosignal measurement device on the basis of a public key generated by the first biosignal measurement device and a public key generated by the server, and encrypt biosignal data measured by the first biosignal measurement device using the generated symmetric key.

According to another aspect of the invention, there is provided a server for remote monitoring of biosignals, the server comprising: a communication unit configured to transmit unique information of a first subject to a first biosignal measurement device, and receive information on matching between unique information of the first biosignal measurement device and the unique information of the first subject; and a control unit configured to generate a symmetric key for the first biosignal measurement device on the basis of a public key generated by the first biosignal measurement device and a public key generated by the server, and decrypt biosignal data received from the first biosignal measurement device using the generated symmetric key.

According to another aspect of the invention, there is provided a method for performing calibration on a biosignal analysis model, the method comprising the steps of: performing a first calibration on a first biosignal analysis model and a second biosignal analysis model; and performing a second calibration on a second biosignal analysis model using output data of the first biosignal analysis model, wherein calibration timing of the second biosignal analysis model comes relatively earlier than calibration timing of the first biosignal analysis model.

According to another aspect of the invention, there is provided a system for performing calibration on a biosignal analysis model, the system comprising: a first calibration management unit configured to perform a first calibration on a first biosignal analysis model and a second biosignal analysis model; and a second calibration management unit configured to perform a second calibration on a second biosignal analysis model using output data of the first biosignal analysis model, wherein calibration timing of the second biosignal analysis model comes relatively earlier than calibration timing of the first biosignal analysis model.

According to another aspect of the invention, there is provided a method for measuring a photoplethysmogram (PPG) signal in a biosignal measurement device, the method comprising the steps of: acquiring a biosignal related to a pulse wave measured from a body part where the biosignal measurement device is worn; calculating a magnitude of a direct current (DC) component included in the biosignal; and adjusting the DC component included in the biosignal with reference to the magnitude of the DC component and a reference value.

According to another aspect of the invention, there is provided a device for measuring a photoplethysmogram (PPG) signal in a biosignal measurement device, the device comprising: a signal acquisition unit configured to acquire a biosignal related to a pulse wave measured from a body part where the biosignal measurement device is worn; and a signal processing unit configured to calculate a magnitude of a direct current (DC) component included in the biosignal, and adjust the DC component included in the biosignal with reference to the magnitude of the DC component and a reference value.

According to another aspect of the invention, there is provided a method for supporting wireless interworking of devices, comprising the steps of: causing a packet containing trigger information to be transmitted in an advertising mode, in response to occurrence of an event for wireless interworking; and causing a connection mode to be activated on the basis of a result of verifying the trigger information, and causing a packet containing information associated with the event to be transmitted in the connection mode.

According to another aspect of the invention, there is provided a system for supporting wireless interworking of devices, comprising: an advertising mode management unit configured to cause a packet containing trigger information to be transmitted in an advertising mode, in response to occurrence of an event for wireless interworking; and a connection mode management unit configured to cause a connection mode to be activated on the basis of a result of verifying the trigger information, and cause a packet containing information associated with the event to be transmitted in the connection mode.

According to another aspect of the invention, there is provided a method for estimating arrhythmia using a composite artificial neural network, comprising the steps of: estimating a class corresponding to a beat segment included in a first section of an electrocardiogram (ECG) signal, using a first artificial neural network; estimating a class corresponding to the first section of the ECG signal, using a second artificial neural network; and mutually verifying the estimated class corresponding to the beat segment included in the first section of the ECG signal and the estimated class corresponding to the first section of the ECG signal.

According to another aspect of the invention, there is provided a system for estimating arrhythmia using a composite artificial neural network, comprising: a first estimation unit configured to estimate a class corresponding to a beat segment included in a first section of an electrocardiogram (ECG) signal, using a first artificial neural network; a second estimation unit configured to estimate a class corresponding to the first section of the ECG signal, using a second artificial neural network; and a verification unit configured to mutually verify the estimated class corresponding to the beat segment included in the first section of the ECG signal and the estimated class corresponding to the first section of the ECG signal.

According to another aspect of the invention, there is provided a device for monitoring a biosignal, comprising: a support where an electrode is formed; an attachment part formed on a lower surface of the support, and provided with a first hole formed in a position corresponding to the electrode; a first cover layer configured to cover a lower surface of the attachment part, and provided with a second hole formed in a position corresponding to the first hole; an attachment pad electrically connected to the electrode via the first hole and the second hole; and a second cover layer configured to cover a part of the first cover layer where the attachment pad is exposed.

According to another aspect of the invention, there is provided a method for assisting in biosignal analysis using clustering, the method comprising the steps of: extracting features from a plurality of pieces of biosignal data for a biosignal, and generating a plurality of feature vectors for the plurality of pieces of biosignal data, respectively, on the basis of the extracted features; and performing clustering on the plurality of pieces of biosignal data with reference to the plurality of feature vectors.

According to another aspect of the invention, there is provided a system for assisting in biosignal analysis using clustering, the system comprising: a feature extraction unit configured to extract features from a plurality of pieces of biosignal data for a biosignal, and generate a plurality of feature vectors for the plurality of pieces of biosignal data, respectively, on the basis of the extracted features; and a clustering management unit configured to perform clustering on the plurality of pieces of biosignal data with reference to the plurality of feature vectors.

According to another aspect of the invention, there is provided a device for monitoring a biosignal, the device comprising a main body unit and an electrode unit detachably coupled to the main body unit, wherein the electrode unit includes two or more electrodes for acquiring the biosignal and a circuit unit for electrically connecting the electrodes and the main body unit.

According to another aspect of the invention, there is further provided a device for monitoring a biosignal, the device comprising: a main body unit; and an electrode unit being detachably coupled to the main body unit and including two or more electrodes for acquiring a biosignal, wherein the main body unit is configured to determine an inter-electrode distance applied to a subject with reference to information on physical characteristics of the subject, and decide whether a distance between the two or more electrodes included in the electrode unit corresponds to the determined inter-electrode distance.

According to another aspect of the invention, there is further provided a method for monitoring a biosignal, the method comprising the steps of: determining an inter-electrode distance applied to a subject with reference to information on physical characteristics of the subject; and in response to a main body unit being detachably coupled to an electrode unit including two or more electrodes for acquiring a biosignal, deciding whether a distance between the two or more electrodes included in the electrode unit corresponds to the determined inter-electrode distance.

In addition, there are further provided other methods, devices, and servers to implement the invention, as well as non-transitory computer-readable recording media having stored thereon computer programs for executing the methods.

According to the invention, it is possible to provide a system capable of remotely monitoring a subject's health condition by continuously measuring biosignals of the subject in response to various environments.

According to the invention, it is possible to easily perform calibration on a biosignal analysis model without visiting a hospital by using output data of one biosignal analysis model to perform calibration on another biosignal analysis model that requires calibration.

According to the invention, it is possible to adaptively adjust a direct current (DC) component included in a biosignal measured from a body part where a biosignal measurement device is worn, thereby preventing the biosignal from being distorted or lost even when amplifying intensity of the biosignal.

According to the invention, it is possible to accurately measure a photoplethysmogram (PPG) signal by adjusting a DC component of a biosignal related to a pulse wave to meet requirements demanded by a biosignal measurement device, a sensor, an external device, or a server.

According to the invention, it is possible to determine a reference value that serves as a criterion for adjusting a DC component included in a biosignal using a machine learning-based decision model, thereby adjusting the DC component included in the biosignal considering various factors such as characteristics of a subject, measurement environment, and system requirements.

According to the invention, it is possible to ensure that connections between wearable monitoring devices and gateways are intermittently maintained in a communication network where Bluetooth Low Energy (BLE) communication scheme is implemented, thereby maximizing the number of wearable monitoring devices that can be connected to one gateway, and maximizing the efficiency of installing gateways in a medical institution.

According to the invention, it is possible to improve the accuracy of arrhythmia estimation by compositely using an artificial neural network trained to estimate which type of arrhythmia a beat segment included in a given section of an ECG signal corresponds to, and an artificial neural network trained to estimate which type of arrhythmia the given section of the ECG signal corresponds to.

According to the invention, it is possible to provide a wearable monitoring device that may minimize deterioration of attachment strength of an attachment surface, while allowing an attachment location to be selected for clear biosignal measurement.

According to the invention, it is possible to provide a wearable monitoring device that allows only a part where an attachment surface is formed to be easily replaced, when an unintended deterioration of attachment strength of the attachment surface occurs while monitoring a biosignal.

According to the invention, it is possible to allow medical personnel to efficiently inspect biosignal data and its analysis results on the basis of clusters, without experiencing the inefficiency of thoroughly inspecting the biosignal data.

According to the invention, it is possible to utilize various information obtained from biosignal data to improve the accuracy of clustering and adjust the number of clusters situationally, thereby enhancing both the efficiency and reliability of inspection of biosignal data analysis results by medical personnel.

According to the invention, it is possible to provide a wearable monitoring device capable of collecting various biosignals and accurately identifying a patient's heart disease by employing an electrode unit including various electrode arrangements or two or more electrodes depending on the patient's condition.

According to the invention, it is possible to provide a wearable monitoring device capable of collecting various biosignals in a single main body by allowing various types of electrode units to be coupled to the single main body.

According to the invention, it is possible to drastically reduce deviations in measured signals due to physical characteristics of a subject wearing a wearable monitoring device by implementing an inter-electrode distance suitable for the physical characteristics of the subject.

According to the invention, it is possible to provide a wearable monitoring device capable of coping with physical characteristics of various subjects with a single main body unit by allowing electrode units having various inter-electrode distances to be detachably coupled to the main body unit.

### BRIEF DESCRIPTION OF THE DRAWINGS

FIG. 1 schematically shows the configuration of an entire system for remote monitoring of biosignals according to one embodiment of the invention.

FIG. 2 illustratively shows an implementation example of the entire system for remote monitoring of biosignals according to one embodiment of the invention.

FIG. 3 illustratively shows the results of wireless interworking according to a third embodiment of the invention.

FIG. 4 illustratively shows how to estimate arrhythmia using a composite artificial neural network according to a fourth embodiment of the invention.

FIG. 5 illustratively shows an exploded perspective view of a biosignal measurement device 5 according to a fifth embodiment of the invention.

FIG. 6 illustratively shows biosignal data to be clustered according to a sixth embodiment of the invention.

FIG. 7 illustratively shows the structure of a model used for feature extraction according to the sixth embodiment of the invention.

FIG. 8 illustratively shows the results of performing hierarchical clustering according to the sixth embodiment of the invention.

FIG. 9 illustratively shows a degree to which interpretation efficiency of an inspector increases as clustering is performed according to the sixth embodiment of the invention.

FIGS. 10 to 13 illustratively show the results of performing clustering on electrocardiogram signal data according to the sixth embodiment of the invention.

FIGS. 14 to 16 illustratively show a main body unit and an electrode unit according to a seventh embodiment of the invention.

FIG. 17 illustratively shows a situation in which a biosignal is stored separately for each channel according to the seventh embodiment of the invention.

FIG. 18 illustratively shows the configuration of a biosignal measurement device according to an eighth embodiment of the invention.

### DESCRIPTION OF THE REFERENCE NUMERALS

10: subject
100: communication network
200: biosignal measurement device
300: server
400: data extraction device
500: gateway
600: viewing/editing device
700: setting device

### DETAILED DESCRIPTION

In the following detailed description of the present invention, references are made to the accompanying drawings that show, by way of illustration, specific embodiments in which the invention may be practiced. These embodiments are described in sufficient detail to enable those skilled in the art to practice the invention. It is to be understood that the various embodiments of the invention, although different from each other, are not necessarily mutually exclusive. For example, specific shapes, structures and characteristics described herein may be implemented as modified from one embodiment to another without departing from the spirit and scope of the invention. Furthermore, it shall be understood that the positions or arrangements of individual elements within each embodiment may also be modified without departing from the spirit and scope of the invention. Therefore, the following detailed description is not to be taken in a limiting sense, and the scope of the invention is to be taken as encompassing the scope of the appended claims and all equivalents thereof. In the drawings, like reference numerals refer to the same or similar elements throughout the several views.

Hereinafter, various preferred embodiments of the invention will be described in detail with reference to the accompanying drawings to enable those skilled in the art to easily implement the invention.

### Configuration of the Entire System

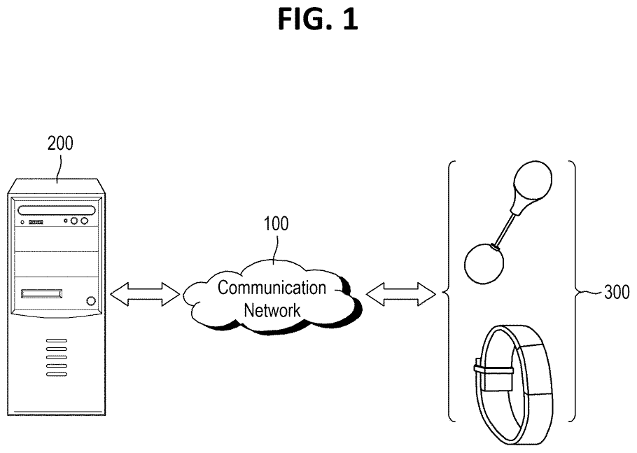

FIG. 1 schematically shows the configuration of the entire system for remote monitoring of biosignals according to one embodiment of the invention.

As shown in FIG. 1, the entire system according to one embodiment of the invention may comprise a communication network 100, a biosignal measurement device 200, and a server 300. The entire system according to one embodiment of the invention may further comprise a data extraction device 400, a gateway 500, a viewing/editing device 600, a setting device 700, and the like.

First, the communication network 100 according to one embodiment of the invention may be implemented regardless of communication modality such as wired and wireless communications, and may be constructed from a variety of communication networks such as local area networks (LANs), metropolitan area networks (MANs), and wide area networks (WANs).

Preferably, the communication network 100 described herein may be a personal area network (PAN), at least a part of which may be implemented with a communication scheme such as Bluetooth communication (more specifically, Bluetooth Low Energy (BLE) communication), ANT+, and Zigbee.

However, the communication network 100 is not necessarily limited thereto, and may at least partially include known wired/wireless data communication networks, known telephone networks, or known wired/wireless television communication networks. For example, the communication network 100 may be a wireless data communication network, at least a part of which may be implemented with a conventional communication scheme such as radio frequency (RF) communication, WiFi communication, cellular communication (e.g., Long Term Evolution (LTE)), infrared communication, and ultrasonic communication.

Next, the biosignal measurement device 200 according to one embodiment of the invention is digital equipment capable of communicating with the server 300, the data extraction device 400, the gateway 500, the setting device 700, and the like via the communication network 100, and having a memory means and a microprocessor for computing capabilities, such as a smart patch, a smart watch, a smart band, and smart glasses, and may be a wearable device including a sensing means (e.g., a contact electrode or an imaging apparatus) for measuring a biosignal (e.g., an electrocardiogram (ECG), an electromyogram (EMG), an electroencephalogram (EEG), a photoplethysmogram (PPG), body temperature, or brainwaves) from a human body.

Further, the biosignal measurement device 200 according to one embodiment of the invention may be a wearable device including a display means for providing a user with a variety of information on the measurement of the biosignal or the operational status of the device.

Furthermore, the biosignal measurement device 200 according to one embodiment of the invention may encrypt biosignal data measured from a subject by the sensing means and store it in a storage unit (or memory).

In addition, the biosignal measurement device 200 according to one embodiment of the invention may transmit the biosignal data stored in the storage unit to the data extraction device 400 via a serial communication interface or to the gateway 500 via a wired/wireless communication interface, and the transmitted biosignal data may be transmitted to the server 300.

Meanwhile, the biosignal measurement device 200 according to one embodiment of the invention may include an application (not shown) for supporting the functions associated with the biosignal measurement. The application may be downloaded from the server 300 or an external application distribution server (not shown). Meanwhile, the characteristics of the application may be generally similar to those of program modules provided in the server 300 to be described below. Here, at least a part of the application may be replaced with a hardware device or a firmware device that may perform a substantially equal or equivalent function, as necessary.

Next, the server 300 according to one embodiment of the invention may communicate with the biosignal measurement device 200 to be described below via the communication network 100, and may also communicate with the gateway 500, the viewing/editing device 600, the setting device 700, and the like.

Further, the server 300 according to one embodiment of the invention may receive biosignal data acquired through the data extraction device 400 or the gateway 500. According to one embodiment of the invention, since the biosignal data received by the server 300 may be encrypted by the biosignal measurement device 200, the server 300 may decrypt the biosignal data using a symmetric key for each biosignal measurement device 200.

Furthermore, the server 300 according to one embodiment of the invention may analyze the biosignal data to generate monitoring information on health condition of the subject. For example, the server 300 according to one embodiment of the invention may analyze electrocardiogram signal data to generate monitoring information on heart diseases such as arrhythmia, myocardial infarction, and heart failure of the subject. As another example, the server 300 according to one embodiment of the invention may analyze body temperature or oxygen saturation data to generate monitoring information on the user's vital signs.

Specifically, the server 300 according to one embodiment of the invention may analyze the biosignal data using various analysis algorithms such as rule-based algorithms and machine learning algorithms.

Further, the server 300 according to one embodiment of the invention may store the generated monitoring information in the storage unit and allow the viewing/editing device 600 to access it via a wired/wireless communication interface. Furthermore, the server 300 according to one embodiment of the invention may edit at least a part of the monitoring information on the basis of user (e.g., medical personnel or administrator) operation data received from the viewing/editing device 600.

Meanwhile, the server 300 according to one embodiment of the invention may be digital equipment having a memory means and a microprocessor for computing capabilities, and may be, for example, a server system operating on the communication network 100.

Next, the data extraction device 400 according to one embodiment of the invention is equipment capable of directly connecting to and communicate with the above-described biosignal measurement device 200, and communicating with the server 300 via the communication network 100, and may function to extract the biosignal data stored in the storage unit of the biosignal measurement device 200 at high speed via a data extraction path provided by the biosignal measurement device 200.

Specifically, the data extraction device 400 according to one embodiment of the invention may implement a high-speed clock using an external power source provided separately from the biosignal measurement device 200, and may include a high-speed quad serial peripheral interface (SPI), a high-speed USB controller, and the like required for high-speed extraction of large-sized biosignal data. In addition, the data extraction device 400 according to one embodiment of the invention may extract the encrypted biosignal data, and the extracted biosignal data may be transmitted to the server 300 while maintaining the encrypted state.

Further, the data extraction device 400 according to one embodiment of the invention may further include a high-performance application processor (AP), an Ethernet controller, a WiFi controller and the like required to transmit the large-sized biosignal data extracted at high speed to the outside (e.g., to the server 300) again.

Meanwhile, the above description is illustrative although the data extraction device 400 has been described as above, and it is noted that at least a part of the functions or components required for the data extraction device 400 may be implemented or included in the biosignal measurement device 200, as necessary.

Next, the gateway 500 according to one embodiment of the invention is equipment capable of communicating with the biosignal measurement device 200 or the server 300 via the communication network 100, and may function to receive the biosignal data stored in the biosignal measurement device 200 and transmit it to the server 300.

Specifically, the gateway 500 according to one embodiment of the invention may receive the biosignal data from the biosignal measurement device 200 through short-range wireless communication such as Bluetooth Low Energy (BLE), and may transmit the received biosignal data to the server 300 through wired/wireless communication such as Ethernet, Wi-Fi, or LTE.

Further, the gateway 500 according to one embodiment of the invention may be implemented in the form of a separate portable device or an installed device, or in the form of a program module (e.g., an application) provided in a general user's smart phone.

Next, the viewing/editing device 600 according to one embodiment of the invention is equipment capable of communicating with the server 300 via the communication network 100, and may function to allow a user (e.g., administrator or medical personnel) to access the analysis result information or monitoring information stored in the server 300 and view or edit the information.

Specifically, the viewing/editing device 600 according to one embodiment of the invention may register (or store) a subject as a measurement target in the server 300, with reference to information of the subject inputted by the user.

Further, the viewing/editing device 600 according to one embodiment of the invention may allow the user to view the biosignal data, biosignal analysis result information, monitoring information, and the like of the subject stored in the server 300, with reference to the information of the subject inputted by the user.

Furthermore, the viewing/editing device 600 according to one embodiment of the invention may allow at least a part of the results of analysis performed by the server 300 to be modified or edited according to user operations inputted by the user. For example, the user may input user operations to modify or edit erroneous parts of the analysis results of the server 300 through the viewing/editing device 600, and the modified or edited information may be stored in the server 300 (i.e., the existing information stored in the server 300 may be updated).

In addition, the viewing/editing device 600 according to one embodiment of the invention may be implemented in the form of a separate portable device or an installed device, or in the form of a program module (e.g., an application) provided in the user's smart phone.

Next, the setting device 700 according to one embodiment of the invention may be equipment capable of communicating with the biosignal measurement device 200 or the server 300 via the communication network 100.

Specifically, the setting device 700 according to one embodiment of the invention may communicate with the server 300 to retrieve a list of subjects registered in the server 300, and may acquire information (or unique information) of a target subject who is selected from the list to wear the biosignal measurement device 200. Further, the setting device 700 according to one embodiment of the invention may communicate with the biosignal measurement device 200 to acquire information (or unique information) of the biosignal measurement device 200 to be worn by the target subject. Furthermore, the setting device 700 according to one embodiment of the invention may function to match the unique information of the target subject and the unique information of the biosignal measurement device 200 acquired as above, and transmit them to the server 300. Therefore, it is possible to clearly specify whose biosignal data is measured by the biosignal measurement device 200 and transmitted to the server 300.

In addition, the setting device 700 according to one embodiment of the invention may transmit a command for initiation of biosignal measurement and storage to the target biosignal measurement device 200, in response to matching between the target biosignal measurement device 200 and the target subject, and the measurement and storage functions of the target biosignal measurement device 200 may accordingly be activated.

Further, the setting device 700 according to one embodiment of the invention may receive a public key generated by the target biosignal measurement device 200 whose measurement and storage functions are activated (or whose matching with the subject is completed) from the target biosignal measurement device 200 and transmit it to the server 300. Furthermore, the setting device 700 according to one embodiment of the invention may receive a public key of the server 300 from the server 300 and transmit it to the target biosignal measurement device 200. That is, the setting device 700 according to one embodiment of the invention may assist the target biosignal measurement device 200 and the server 300 to exchange the keys as above, thereby enabling the target biosignal measurement device 200 and the server 300 to generate a symmetric key for each device. Therefore, according to one embodiment of the invention, on the basis of the symmetric key for each device, encryption of biosignal data may be performed in the target biosignal measurement device 200, and decryption of received biosignal data may be performed in the server 300.

However, it is noted that the encryption method according to the invention is not necessarily limited to the symmetric key method described above, but may be changed without limitation as long as the object of the invention may be achieved.

In addition, the setting device 700 according to one embodiment of the invention may be implemented in the form of a separate portable device or an installed device, or in the form of a program module (e.g., an application) provided in the user's smart phone.

### Configuration of the Biosignal Measurement Device

Hereinafter, the internal configuration of the biosignal measurement device 200 crucial for implementing the invention and the functions of the respective components thereof will be discussed.

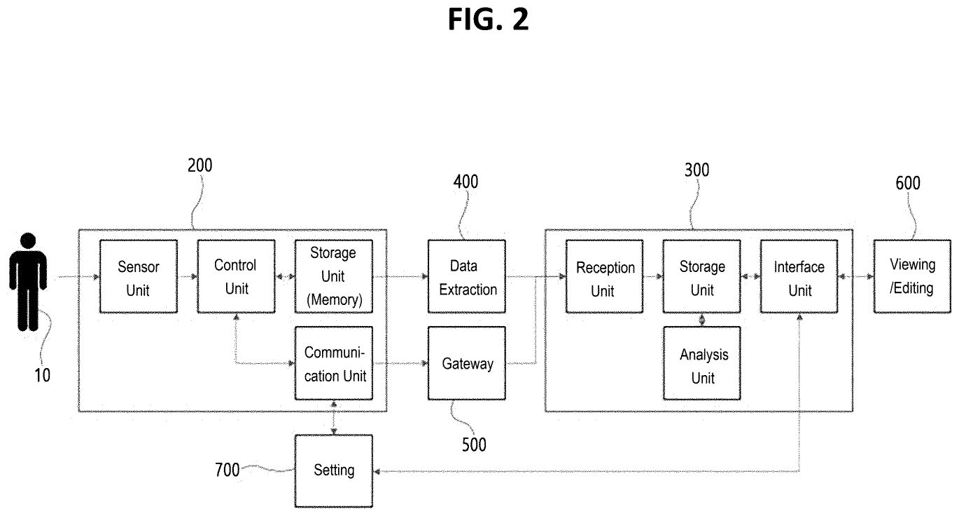

As shown in FIG. 2, the biosignal measurement device 200 according to one embodiment of the invention may comprise a sensor unit, a storage unit, a communication unit, and a control unit. According to one embodiment of the invention, at least some of the sensor unit, the storage unit, the communication unit, and the control unit of the biosignal measurement device 200 may be program modules to communicate with an external system (not shown). The program modules may be included in the biosignal measurement device 200 in the form of operating systems, application program modules, or other program modules, while they may be physically stored in a variety of commonly known storage devices. Further, the program modules may also be stored in a remote storage device that may communicate with the biosignal measurement device 200. Meanwhile, such program modules may include, but are not limited to, routines, subroutines, programs, objects, components, data structures, and the like for performing specific tasks or executing specific abstract data types as will be described below in accordance with the invention.

Meanwhile, the above description is illustrative although the biosignal measurement device 200 has been described as above, and it will be apparent to those skilled in the art that at least a part of the components or functions of the biosignal measurement device 200 may be implemented in the server 300, the data extraction device 400, the gateway 500, the viewing/editing device 600, or the setting device 700 or included in an external system (not shown), as necessary.

### Configuration of the Server

Hereinafter, the internal configuration of the server 300 crucial for implementing the invention and the functions of the respective components thereof will be discussed.

As shown in FIG. 2, the server 300 according to one embodiment of the invention may comprise a reception unit, a storage unit, an analysis unit, and an interface unit. According to one embodiment of the invention, at least some of the reception unit, the storage unit, the analysis unit, and the interface unit of the server 300 may be program modules to communicate with an external system (not shown). The program modules may be included in the server 300 in the form of operating systems, application program modules, or other program modules, while they may be physically stored in a variety of commonly known storage devices. Further, the program modules may also be stored in a remote storage device that may communicate with the server 300. Meanwhile, such program modules may include, but are not limited to, routines, subroutines, programs, objects, components, data structures, and the like for performing specific tasks or executing specific abstract data types as will be described below in accordance with the invention.

Meanwhile, the above description is illustrative although the server 300 has been described as above, and it will be apparent to those skilled in the art that at least a part of the components or functions of the sever 300 may be implemented in the biosignal measurement device 200, the data extraction device 400, the gateway 500, the viewing/editing device 600, or the setting device 700 or included in an external system (not shown), as necessary.

### First Embodiment

Hereinafter, the internal configuration of the server 300 for performing calibration on a biosignal analysis model according to a first embodiment of the invention and the functions of the respective components thereof will be discussed.

The server 300 according to the first embodiment of the invention may comprise a first calibration management unit (not shown), a second calibration management unit (not shown), a communication unit (not shown), and a control unit (not shown). According to one embodiment of the invention, at least some of the first calibration management unit, the second calibration management unit, the communication unit, and the control unit of the server 300 may be program modules to communicate with an external system (not shown). The program modules may be included in the server 300 in the form of operating systems, application program modules, or other program modules, while they may be physically stored in a variety of commonly known storage devices. Further, the program modules may also be stored in a remote storage device that may communicate with the server 300. Meanwhile, such program modules may include, but are not limited to, routines, subroutines, programs, objects, components, data structures, and the like for performing specific tasks or executing specific abstract data types as will be described below in accordance with the invention.

Meanwhile, the above description is illustrative although the server 300 has been described as above, and it will be apparent to those skilled in the art that at least a part of the components or functions of the server 300 may be implemented in the biosignal measurement device 200 or a server (not shown) or included in an external system (not shown), as necessary.

First, the first calibration management unit according to one embodiment of the invention may perform a first calibration on a first biosignal analysis model and a second biosignal analysis model.

Here, the first biosignal analysis model and the second biosignal analysis model on which the first calibration is performed according to one embodiment of the invention may analyze biosignal data of a subject to estimate the subject's condition or disease. For example, according to one embodiment of the invention, the first biosignal analysis model and the second biosignal analysis model may analyze a photoplethysmogram (PPG) of a subject to estimate the subject's blood pressure (BP). As another example, according to one embodiment of the invention, the first biosignal analysis model and the second biosignal analysis model may an electrocardiogram (ECG) of a subject to estimate the subject's arrhythmia.

Meanwhile, the first biosignal analysis model and the second biosignal analysis model according to one embodiment of the invention may analyze the same type of biosignal data to estimate the same condition or disease, but their attributes (or specifications) may be different. Specifically, according to one embodiment of the invention, the first biosignal analysis model may have higher accuracy in biosignal analysis than the second biosignal analysis model, and the first biosignal analysis model may have a larger size of inputted biosignal data than the second biosignal analysis model.

Further, according to one embodiment of the invention, the first biosignal analysis model may have a longer calibration cycle than the second biosignal analysis model. For example, the calibration cycle of the first biosignal analysis model may be 4 weeks, and the calibration cycle of the second biosignal analysis model may be 2 weeks, which is shorter than the calibration cycle of the first biosignal analysis model. However, according to one embodiment of the invention, the calibration cycle of each biosignal analysis model may be diversely changed with reference to a predetermined criterion, and is not necessarily limited to the above example.

In addition, according to one embodiment of the invention, the biosignal measurement devices to which the first biosignal analysis model and the second biosignal analysis model are applied may be different. Specifically, according to one embodiment of the invention, the devices to which the first biosignal analysis model and the second biosignal analysis model are applied may differ in shapes, locations where the devices form contact points with the subject's body, and the like. For example, the device to which the first biosignal analysis model is applied may be a patch-type device that forms a contact point on the subject's chest, and the device to which the second biosignal analysis model is applied may be a watch-type device that forms a contact point on the subject's wrist.

Meanwhile, the first calibration according to one embodiment of the invention may be performed on at least one of the first biosignal analysis model and the second biosignal analysis model described above, using measurement data of an external device (not shown). Here, the external device according to one embodiment of the invention may be calibration equipment provided in a medical institution such as a hospital, and may be a device for estimating the same condition or disease as the subject's condition or disease estimated by the first biosignal analysis model and the second biosignal analysis model. For example, assuming that the subject's condition or disease estimated by the first biosignal analysis model and the second biosignal analysis model is the subject's blood pressure, the external device according to one embodiment of the invention may be a blood pressure monitor provided in a medical institution (wherein the blood pressure monitor may include a cuff), which may be a device for outputting the subject's blood pressure as measurement data.

More specifically, according to one embodiment of the invention, during the course of the first calibration, the subject's condition or disease may be estimated using at least one of the first biosignal analysis model and the second biosignal analysis model (or at least one of the device to which the first biosignal analysis model is applied and the device to which the second biosignal analysis model is applied) together with the external device. The first calibration management unit according to one embodiment of the invention may use measurement data of the external device, which is one of results of the estimation, as reference data for performing the first calibration on at least one of the first biosignal analysis model and the second biosignal analysis model. For example, the first calibration management unit according to one embodiment of the invention may acquire (or receive) the measurement data of the external device, and adjust internal parameters of at least one of the first biosignal analysis model and the second biosignal analysis model such that at least one of the first biosignal analysis model and the second biosignal analysis model outputs data identical to the measurement data of the external device (or similar to the measurement data of the external device within a predetermined range).

Next, the second calibration management unit according to one embodiment of the invention may perform a second calibration on a second biosignal analysis model using output data of the first biosignal analysis model, wherein calibration timing of the second biosignal analysis model comes relatively earlier than calibration timing of the first biosignal analysis model.

According to one embodiment of the invention, even if the first biosignal analysis model and the second biosignal analysis model have been calibrated, calibration should be performed again at predetermined cycles to maintain the accuracy of biosignal analysis, which may degrade over time, at a desired level. However, the above-described first calibration method may be inconvenient in that it may only be performed when the subject visits a medical institution such as a hospital. Therefore, hereinafter, a second calibration method will be discussed which may easily perform calibration on a biosignal analysis model (particularly, the second biosignal analysis model) without the subject visiting a medical institution such as a hospital.

The second calibration according to one embodiment of the invention may be performed on the second biosignal analysis model using output data of the first biosignal analysis model. That is, the second calibration according to one embodiment of the invention may be performed when the subject possesses both a device to which the first biosignal analysis model is applied (e.g., a patch-type device) and a device to which the second biosignal analysis model is applied (e.g., a watch-type device).

Specifically, the second biosignal analysis model according to one embodiment of the invention has a shorter calibration cycle than the first biosignal analysis model as described above, so that the calibration timing may come relatively earlier than the first biosignal analysis model. Therefore, the second calibration management unit according to one embodiment of the invention may perform the second calibration on the second biosignal analysis model using the output data of the first biosignal analysis model, which maintains the accuracy of biosignal analysis relatively better than the second biosignal analysis model.

More specifically, according to one embodiment of the invention, during the course of the second calibration, the subject's condition or disease may be estimated using the first biosignal analysis model and the second biosignal analysis model (or the device to which the first biosignal analysis model is applied and the device to which the second biosignal analysis model is applied) together. The second calibration management unit according to one embodiment of the invention may use the output data of the first biosignal analysis model, which is one of results of the estimation, as reference data for performing the second calibration on the second biosignal analysis model. For example, the second calibration management unit according to one embodiment of the invention may acquire (or receive) the output data of the first biosignal analysis model, and adjust internal parameters of the second biosignal analysis model such that the second biosignal analysis model outputs data identical to the output data of the first biosignal analysis model (or similar to the output data of the first biosignal analysis model within a predetermined range).

Meanwhile, according to one embodiment of the invention, the second calibration management unit may periodically perform the second calibration on the second biosignal analysis model with reference to the calibration cycle of the second biosignal analysis model as described above, or may non-periodically perform the second calibration on the second biosignal analysis model with reference to a predetermined event related to the second biosignal analysis model. That is, according to one embodiment of the invention, the second calibration on the second biosignal analysis model may be performed with reference to a predetermined event related to the second biosignal analysis model that occurs non-periodically, so that the accuracy of biosignal analysis of the second biosignal analysis model, which may degrade due to environmental changes, may be maintained at a desired level.

For example, the predetermined event related to the second biosignal analysis model according to one embodiment of the invention may include the number of times the second biosignal analysis model performs biosignal analysis exceeding a predetermined number. More specifically, according to one embodiment of the invention, even if the calibration timing according to the calibration cycle of the second biosignal analysis model has not yet come, the accuracy of biosignal analysis may degrade when the number of times the second biosignal analysis model performs biosignal analysis exceeds a predetermined number. Therefore, the second calibration management unit according to one embodiment of the invention may perform the second calibration on the second biosignal analysis model in the above case. Here, the predetermined number according to one embodiment of the invention may be preset or dynamically set considering the degree of degradation in the accuracy of biosignal analysis of the second biosignal analysis model due to the increase in the number of times the second biosignal analysis model performs biosignal analysis. Meanwhile, it is noted that the predetermined event related to the second biosignal analysis model according to one embodiment of the invention is not necessarily limited to the above example, but may encompass diverse events as long as the object of the invention may be achieved.

Next, the communication unit according to one embodiment of the invention may function to enable data transmission/reception from/to the first calibration management unit and the second calibration management unit.

Lastly, the control unit according to one embodiment of the invention may function to control data flow among of the first calibration management unit, the second calibration management unit, and the communication unit. That is, the control unit according to the invention may control data flow into/out of the server 300 or data flow among the respective components of the server 300, such that the first calibration management unit, the second calibration management unit, and the communication unit may carry out their particular functions, respectively.

Although the embodiments in which the biosignal analysis model (i.e., the first biosignal analysis model and the second biosignal analysis model) subject to calibration estimates a subject's blood pressure have been mainly described above, it is noted that the biosignal analysis model subject to calibration is not necessarily limited to a model estimating the subject's blood pressure, but may encompass models estimating other conditions or diseases of the subject as long as the object of the invention may be achieved.

Further, although performing calibration has been described above as adjusting internal parameters of a biosignal analysis model using reference data, it is noted that the calibration can be expressed (or replaced) by various terms such as update, fitting, renewal, and version upgrade as long as the object of the invention may be achieved.

### Second Embodiment

Hereinafter, the internal configuration of the biosignal measurement device 200 for measuring a photoplethysmogram (PPG) signal according to a second embodiment of the invention and the functions of the respective components thereof will be discussed.

The biosignal measurement device 200 according to the second embodiment of the invention may comprise a signal acquisition unit (not shown), a signal processing unit (not shown), a communication unit (not shown), and a control unit (not shown). According to one embodiment of the invention, at least some of the signal acquisition unit, the signal processing unit, the communication unit, and the control unit may be program modules to communicate with an external device or the server 300. The program modules may be included in the biosignal measurement device 200 in the form of operating systems, application program modules, or other program modules, while they may be physically stored in a variety of commonly known storage devices. Further, the program modules may also be stored in a remote storage device that may communicate with the biosignal measurement device 200. Meanwhile, such program modules may include, but are not limited to, routines, subroutines, programs, objects, components, data structures, and the like for performing specific tasks or executing specific abstract data types as will be described below in accordance with the invention.

First, according to one embodiment of the invention, the signal acquisition unit may acquire a biosignal related to a pulse wave measured by a biosignal measurement device worn by a subject.

Specifically, according to one embodiment of the invention, when a light source (not shown) included in the biosignal measurement device worn by the subject irradiates light onto a body part of the subject (e.g., wrist), a sensor (not shown) included in the biosignal measurement device may sense light reflected, transmitted, or scattered from body tissue (e.g., blood vessels) present in the body part, and a photoplethysmogram (PPG) signal may be measured on the basis of the sensed light signal.

Further, according to one embodiment of the invention, the signal acquisition unit may acquire a first biosignal measured when light is irradiated from the light source and acquire a second biosignal measured when light is not irradiated from the light source and only ambient light is present, and may remove noise components due to the ambient light from the first biosignal with reference to the first biosignal and the second biosignal acquired as above.

Next, according to one embodiment of the invention, the signal processing unit may calculate a magnitude of a direct current (DC) component included in the PPG signal measured and acquired by the biosignal measurement device, and may adjust the magnitude of the DC component included in the PPG signal with reference to the calculated magnitude of the DC component and a reference value. Here, according to one embodiment of the invention, the magnitude of the DC component may be adjusted by adjusting feedback current.

Specifically, according to one embodiment of the invention, the signal processing unit may decrease the magnitude of the DC component included in the PPG signal by adjusting the feedback current in response to the magnitude of the DC component being greater than a first reference value (e.g., an upper limit of a reference range), and conversely, may increase the magnitude of the DC component included in the PPG signal by adjusting the feedback current in response to the magnitude of the DC component being less than a second reference value (e.g., a lower limit of the reference range).

Further, according to one embodiment of the invention, the signal processing unit may decrease the DC component included in the PPG by adjusting the feedback current until the magnitude of the DC component becomes less than the first reference value, and conversely, may increase the DC component included in the PPG by adjusting the feedback current until the magnitude of the DC component becomes greater than the second reference value.

In addition, according to one embodiment of the invention, the reference value or reference range, which serves as a criterion for adjusting the magnitude of the DC component included in the PPG signal, may be adaptively determined on the basis of various factors. For example, the reference value or reference range may be adaptively determined on the basis of system requirements of the biosignal measurement device measuring the PPG signal, or system requirements demanded by an external device (not shown) or the server 300 interworking with the biosignal measurement device.

As another example, the reference value or reference range may be adaptively determined on the basis of a ratio between a magnitude of an alternating current (AC) component included in the PPG signal and the magnitude of the DC component.

As another example, the reference value or reference range may be adaptively determined on the basis of information on the subject's physical characteristics (e.g., hemodynamic characteristics) or activity status.

As another example, the reference value or reference range may be adaptively determined on the basis of context information on measurement environment (e.g., ambient light, measurement time, and measurement location).

Meanwhile, according to one embodiment of the invention, a machine learning-based decision model may be constructed which is trained on the basis of learning data related to various factors including the system requirements, the ratio between the magnitudes of the AC component and the DC component, the subject's physical characteristics or activity status, the measurement environment, and the like, and learning data related to a reference value or reference range of the DC component magnitude that prevents the PPG signal from being distorted or lost even when the PPG signal is amplified. Therefore, the signal processing unit according to one embodiment of the invention may dynamically adjust the magnitude of the DC component included in the PPG signal with reference to the reference value or reference range determined by the machine learning-based decision model.

Meanwhile, according to one embodiment of the invention, the signal processing unit may amplify the PPG signal with the DC component magnitude adjusted as above without distortion or loss, thereby generating a PPG signal with a sufficient level of intensity to be utilized for measurement or analysis.

Next, the communication unit according to one embodiment of the invention may function to enable the biosignal measurement device 200 to communicate with an external device.

Lastly, the control unit according to one embodiment of the invention may function to control data flow among of the signal acquisition unit, the signal processing unit, and the communication unit. That is, the control unit may control inbound data flow or data flow among the respective components of the biosignal measurement device 200, such that the signal acquisition unit, the signal processing unit, and the communication unit may carry out their particular functions, respectively.

Although the embodiments in which a DC component included in a PPG signal is adjusted have been mainly described above, it is noted that the present invention is not necessarily limited to the above embodiments, but DC components included in other types of biosignals may also be adjusted without limitation as long as the object of the invention may be achieved.

### Third Embodiment

Hereinafter, the internal configuration of the server 300 or the gateway 500 for supporting wireless interworking of the biosignal measurement device 200 according to a third embodiment of the invention and the functions of the respective components thereof will be discussed.

The server 300 according to one embodiment of the invention may comprise an advertising mode management unit (not shown), a connection mode management unit (not shown), a communication unit (not shown), and a control unit (not shown). According to one embodiment of the invention, at least some of the advertising mode management unit, the connection mode management unit, the communication unit, and the control unit of the server 300 may be program modules to communicate with an external system (not shown). The program modules may be included in the server 300 in the form of operating systems, application program modules, or other program modules, while they may be physically stored in a variety of commonly known storage devices. Further, the program modules may also be stored in a remote storage device that may communicate with the server 300. Meanwhile, such program modules may include, but are not limited to, routines, subroutines, programs, objects, components, data structures, and the like for performing specific tasks or executing specific abstract data types as will be described below in accordance with the invention.

Meanwhile, the above description is illustrative although the server 300 has been described as above, and it will be apparent to those skilled in the art that at least a part of the components or functions of the server 300 may be implemented in the biosignal measurement device 200 or the gateway 500 or included in an external system (not shown), as necessary.

First, the advertising mode management unit according to one embodiment of the invention may function to cause a packet containing trigger information to be transmitted in an advertising mode, in response to occurrence of an event for wireless interworking.

Here, the event for wireless interworking according to one embodiment of the invention may refer to an event requiring transmission of predetermined information from the biosignal measurement device 200 to a gateway (not shown) or a remote monitoring system (not shown) to be described below. According to one embodiment of the invention, the event for wireless interworking may include, but is not limited to, an event regarding abnormal biosignal data being acquired from a subject by the biosignal measurement device 200 (or a sensing means of the biosignal measurement device 200), and may be diversely changed as long as the objects of the invention may be achieved.

The advertising mode management unit according to one embodiment of the invention may assist the biosignal measurement device 200 to wirelessly interwork (or connect) with the gateway 500 in response to the occurrence of the event for wireless interworking. Specifically, the advertising mode management unit according to one embodiment of the invention may assist the biosignal measurement device 200 and the gateway 500 to interwork with each other via the communication network 100 in which a Bluetooth Low Energy (BLE) communication scheme is implemented. Meanwhile, the gateway 500 according to one embodiment of the invention may be provided in a medical institution (e.g., a hospital or health center) and may function to relay communication between the biosignal measurement device 200 worn by a subject (or patient) visiting the medical institution and the remote monitoring system provided in the medical institution (wherein the remote monitoring system may be a system for analyzing or detecting abnormality in the subject's health condition by remotely monitoring information acquired from the subject by the biosignal measurement device 200, and may be the server 300).

More specifically, the advertising mode management unit according to one embodiment of the invention may cause the biosignal measurement device 200 (or a BLE module (not shown) included in the biosignal measurement device 200) to transmit a packet containing trigger information in a BLE advertising mode, in response to the occurrence of the event for wireless interworking. Here, according to one embodiment of the invention, the packet may be an advertising packet or a scan response packet. Further, according to one embodiment of the invention, the trigger information may include first information indicating the occurrence of the event for wireless interworking, and second information on an attribute of the event for wireless interworking (e.g., a type of the event for wireless interworking). According to one embodiment of the invention, the packet containing the trigger information may be transmitted from the biosignal measurement device 200 to the gateway 500, and the gateway receiving the packet may verify the trigger information contained in the packet (e.g., verify the validity or integrity of each of the first information and the second information).

For example, in response to the occurrence of the event for wireless interworking, the advertising mode management unit according to one embodiment of the invention may cause an advertising packet to contain trigger information and cause the advertising packet to be transmitted from the biosignal measurement device 200. Next, the gateway 500 according to one embodiment of the invention may receive the advertising packet transmitted from the biosignal measurement device 200 and verify the trigger information contained in the advertising packet.

As another example, the advertising mode management unit according to one embodiment of the invention may cause an advertising packet to be transmitted from the biosignal measurement device 200. Next, the gateway 500 according to one embodiment of the invention may receive the advertising packet transmitted from the biosignal measurement device 200 and transmit a scan request packet corresponding to the advertising packet to the biosignal measurement device 200. Next, in response to the occurrence of the event for wireless interworking, the advertising mode management unit according to one embodiment of the invention may cause a scan response packet corresponding to the scan request packet to contain trigger information and cause the scan response packet to be transmitted from the biosignal measurement device 200. Next, the gateway 500 according to one embodiment of the invention may receive the scan response packet transmitted from the biosignal measurement device 200 and verify the trigger information contained in the scan response packet.

Next, the connection mode management unit according to one embodiment of the invention may function to causing a connection mode to be activated on the basis of a result of verifying the trigger information, and causing a packet containing information associated with the event for wireless interworking to be transmitted in the connection mode.

Specifically, the connection mode management unit according to one embodiment of the invention may cause a BLE connection mode to be activated when the trigger information has been verified (wherein the verification of the trigger information may be performed by the gateway as described above). Further, the connection mode management unit according to one embodiment of the invention may cause the biosignal measurement device 200 (or the BLE module included in the biosignal measurement device 200) to transmit a packet containing information associated with the event for wireless interworking in the connection mode activated as above. Here, according to one embodiment of the invention, the information associated with the event for wireless interworking may refer to predetermined information that is required to be transmitted to the above-described gateway or remote monitoring system (e.g., the server 300). For example, when the event for wireless interworking is assumed to be an electrocardiogram with an abnormal waveform (e.g., tachycardia or bradycardia) being acquired from the subject by the biosignal measurement device 200 (or the sensing means of the biosignal measurement device 200), the information associated with the event for wireless interworking may be information in which the electrocardiogram is recorded.

For example, it is assumed that the trigger information contained in the advertising packet or scan response packet has been verified. The gateway 500 according to one embodiment of the invention may transmit a connection request packet to the biosignal measurement device 200 on the basis of the result of verifying the trigger information. Next, the connection mode management unit according to one embodiment of the invention may cause connection request acknowledgment information (or a packet containing the information) corresponding to the connection request packet to be transmitted from the biosignal measurement device 200. According to one embodiment of the invention, the connection between the biosignal measurement device 200 and the gateway 500 may be completed through the above process, so that the connection mode management unit according to one embodiment of the invention may cause the connection mode to be activated. Next, the connection mode management unit according to one embodiment of the invention may cause the biosignal measurement device 200 to transmit a packet containing information associated with the event for wireless interworking to the gateway 500 in the connection mode activated as above. Next, the connection mode management unit according to one embodiment of the invention may cause the biosignal measurement device 200 and the gateway 500 to be disconnected when the transmission of the packet containing the information associated with the event for wireless interworking is completed.

According to one embodiment of the invention, the above-described functions of the advertising mode management unit and the connection mode management unit may cause the connection mode to be maintained (or the connection to be maintained) intermittently between the biosignal measurement device 200 and the gateway 500 only when the event for wireless interworking occurs. Thus, according to one embodiment of the invention, it is possible to maximize the number of biosignal measurement devices 200 that can be connected to one gateway 500, and maximize the efficiency of installing gateways in a medical institution.

Meanwhile, according to one embodiment of the invention, while it is important for the connection mode to be intermittently maintained in the biosignal measurement device 200 as described above, it may be important in some cases for the connection mode to be constantly maintained in the biosignal measurement device 200. For example, when the connection mode is constantly maintained in the biosignal measurement device 200, it is possible to continuously monitor the subject's health condition while allowing for rapid response in the event of an emergency. To this end, according to one embodiment of the invention, the biosignal measurement device 200 may be implemented such that a default value is set to cause the connection mode to be intermittently maintained in the biosignal measurement device 200, while the default value is changeable in some cases to cause the connection mode to be constantly maintained in the biosignal measurement device 200. According to one embodiment of the invention, the biosignal measurement device 200 in which the connection mode is constantly maintained may be determined by the subject wearing the biosignal measurement device 200 or the remote monitoring system (e.g., the server 300). Meanwhile, according to one embodiment of the invention, in the biosignal measurement device 200 in which the connection mode is constantly maintained, the connection mode may be activated on the basis of a common BLE communication scheme (specifically, according to the common BLE communication scheme, the aforementioned trigger information is not contained in an advertising packet or a scan response packet), rather than the functions of the advertising mode management unit and the connection mode management unit.

Meanwhile, the connection mode management unit according to one embodiment of the invention may determine the number of gateways 500 to be operated (or the number of gateways needed) with reference to the biosignal measurement devices 200 in which the connection mode is constantly maintained and the biosignal measurement devices 200 in which the connection mode is intermittently maintained.

Specifically, the connection mode management unit according to one embodiment of the invention may increase the number of gateways to be operated in response to the number of biosignal measurement devices 200 in which the connection mode is constantly maintained exceeding at least one threshold value. Here, according to one embodiment of the invention, the at least one threshold value may be a multiple of the maximum number of biosignal measurement devices 200 that can be connected to one gateway. For example, when the maximum number of biosignal measurement devices 200 that can be connected to one gateway is assumed to be 10, the at least one threshold value may be a multiple of 10 (i.e., 10, 20, 30, 40, or the like). In this regard, the connection mode management unit according to one embodiment of the invention may determine the number of gateways to be operated (NoG_ah1) according to Equation 1 below. Here, according to one embodiment of the invention, a may be the number of biosignal measurement devices 200 in which the connection mode is constantly maintained, and N may be the maximum number of biosignal measurement devices 200 that can be connected to one gateway.

NoG_ah1=int((a−1)/N)+1 EQ. 1

Meanwhile, the connection mode management unit according to one embodiment of the invention may determine the number of gateways to be operated on the basis of traffic caused by the biosignal measurement devices 200 in which the connection mode is intermittently maintained, in addition to the number of biosignal measurement devices 200 in which the connection mode is constantly maintained. Specifically, regardless of the absolute number of biosignal measurement devices 200 in which the connection mode is intermittently maintained, the connection mode management unit according to one embodiment of the invention may determine the number of gateways to be operated solely on the basis of traffic caused by the biosignal measurement devices 200 (e.g., traffic generated according to the frequency with which the connection mode is maintained). More specifically, the connection mode management unit according to one embodiment of the invention may determine the number of gateways to be operated by adding the number obtained from Equation 1 above and the number of gateways required on the basis of traffic caused by the biosignal measurement devices 200 in which the connection mode is intermittently maintained.

That is, the connection mode management unit according to one embodiment of the invention may finally determine the number of gateways to be operated (NoG_ah2) according to Equation 2 below. Here, according to one embodiment of the invention, a may be the number of biosignal measurement devices 200 in which the connection mode is constantly maintained, N may be the maximum number of biosignal measurement devices 200 that can be connected to one gateway, and b may be the number of gateways required on the basis of traffic caused by the biosignal measurement devices 200 in which the connection mode is intermittently maintained.

NoG_ah2=int((a−1)/N)+1+b EQ. 2

Next, the communication unit according to one embodiment of the invention may function to enable data transmission/reception from/to the advertising mode management unit and the connection mode management unit.

Lastly, the control unit according to one embodiment of the invention may function to control data flow among of the advertising mode management unit, the connection mode management unit, and the communication unit. That is, the control unit according to the invention may control data flow into/out of the server 300 or data flow among the respective components of the server 300, such that the advertising mode management unit, the connection mode management unit, and the communication unit may carry out their particular functions, respectively.

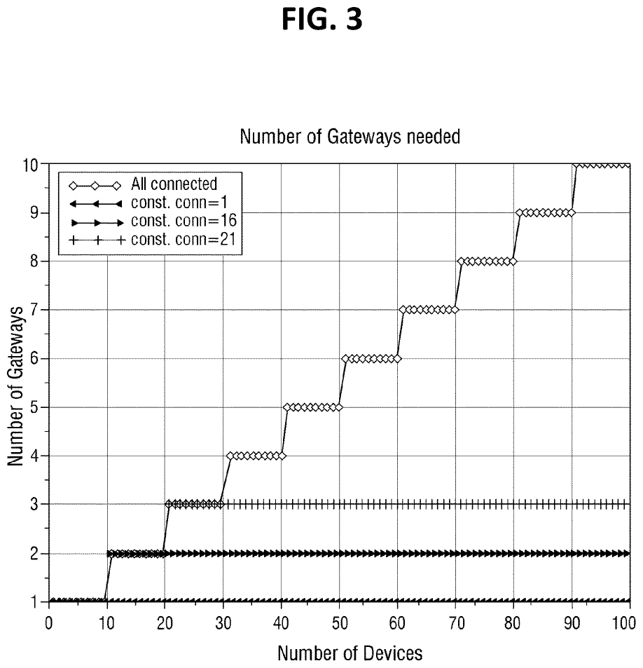

FIG. 3 illustratively shows the results of wireless interworking according to the third embodiment of the invention.

Referring to FIG. 3, with respect to “All connected”, the number of gateways to be operated is shown when all the biosignal measurement devices 200 are the biosignal measurement devices 200 in which the connection mode is constantly maintained, the maximum number of biosignal measurement devices 200 that can be connected to one gateway is 10, and the number of gateways required on the basis of traffic caused by the biosignal measurement devices 200 in which the connection mode is intermittently maintained is zero.

Further, with respect to “const. conn”, the number of gateways to be operated is shown when the number of biosignal measurement devices 200 in which the connection mode is constantly maintained is 1, 16, or 21, the maximum number of biosignal measurement devices 200 that can be connected to one gateway is 10, and the number of gateways required on the basis of traffic caused by the biosignal measurement devices 200 in which the connection mode is intermittently maintained is zero. Here, according to one embodiment of the invention, it can be seen that with respect to “const. conn”, the number of gateways to be operated does not increase even if the absolute number of biosignal measurement devices 200 in which the connection mode is intermittently maintained increases.

### Fourth Embodiment

Hereinafter, the internal configuration of the server 300 for estimating arrhythmia using a composite artificial neural network according to a fourth embodiment of the invention and the functions of the respective components thereof will be discussed.

The server 300 according to the fourth embodiment of the invention may comprise a first estimation unit, a second estimation unit, a verification unit, a communication unit, and a control unit. According to one embodiment of the invention, at least some of the first estimation unit, the second estimation unit, the verification unit, the communication unit, and the control unit of the server 300 may be program modules to communicate with an external system (not shown). The program modules may be included in the server 300 in the form of operating systems, application program modules, or other program modules, while they may be physically stored in a variety of commonly known storage devices. Further, the program modules may also be stored in a remote storage device that may communicate with the server 300. Meanwhile, such program modules may include, but are not limited to, routines, subroutines, programs, objects, components, data structures, and the like for performing specific tasks or executing specific abstract data types as will be described below in accordance with the invention.

Meanwhile, the above description is illustrative although the server 300 has been described as above, and it will be apparent to those skilled in the art that at least a part of the components or functions of the server 300 may be implemented in the biosignal measurement device 200 or included in an external system (not shown), as necessary.

First, the first estimation unit according to one embodiment of the invention may function to estimate a class corresponding to a beat segment included in a first section of an electrocardiogram (ECG) signal, using a first artificial neural network.

Here, the first artificial neural network according to one embodiment of the invention may be an artificial neural network trained to estimate which of classes representing a first type of arrhythmia a beat segment included in a section of the ECG signal corresponds to. Here, the beat segment may refer to a QRS waveform (or QRS complex) appearing in the ECG signal, and may be detected from the ECG signal by the first artificial neural network, or by a means or method other than the first artificial neural network. According to one embodiment of the invention, the first type of arrhythmia may include arrhythmia that may be estimated on a beat segment basis, and may include, for example, atrial premature contraction (APC), ventricular premature contraction (VPC), left bundle branch block (LBBB), and right bundle branch block (RBBB).

Specifically, the first estimation unit according to one embodiment of the invention may use the first artificial neural network to estimate which of the classes representing the first type of arrhythmia at least one beat segment included in the first section of the ECG signal corresponds to, and further estimate that the class corresponding to the beat segment is a class representing a normal ECG, if the beat segment does not correspond to any of the classes representing the first type of arrhythmia.

For example, assuming that the ECG signal is inputted to the first artificial neural network, the first estimation unit may use the first artificial neural network to estimate that a fourth beat segment among five beat segments included in the first section of the ECG signal corresponds to a class representing APC, and estimate that a first beat segment, a second beat segment, a third beat segment, and a fifth beat segment among the five beat segments included in the first section of the ECG signal correspond to the class representing a normal ECG.

Meanwhile, according to one embodiment of the invention, the first artificial neural network comprises an input layer, a hidden layer, and an output layer, and may be implemented as, but is not necessarily limited to, a convolutional neural network (CNN), a recurrent neural network (RNN), or the like.

Next, the second estimation unit according to one embodiment of the invention may function to estimate a class corresponding to the first section of the ECG signal, using a second artificial neural network.

Here, the second artificial neural network according to one embodiment of the invention may be an artificial neural network trained to estimate which of classes representing a second type of arrhythmia a section of the ECG signal corresponds to. According to one embodiment of the invention, the second type of arrhythmia may include arrhythmia that may be estimated from rhythm changes between consecutive beat segments, and may include, for example, atrial fibrillation (AFib), paroxysmal supraventricular tachycardia (SVT), and atrioventricular block (AV block).

Specifically, the second estimation unit according to one embodiment of the invention may use the second artificial neural network to estimate which of the classes representing the second type of arrhythmia the first section of the ECG signal corresponds to, and further estimate that the class corresponding to the first section is the class representing a normal ECG, if the first section does not correspond to any of the classes representing the second type of arrhythmia.

For example, assuming that the ECG signal is inputted to the second artificial neural network, the second estimation unit may use the second artificial neural network to estimate that the first section of the ECG signal corresponds to a class representing AFib, or estimate that the first section of the ECG signal corresponds to the class representing a normal ECG.

According to one embodiment of the invention, the second artificial neural network may be configured in parallel with the first artificial neural network, and the same ECG signal may be inputted to the first artificial neural network and the second artificial neural network configured in parallel. That is, with respect to the same ECG signal, the first artificial neural network may estimate which of the classes representing the first type of arrhythmia the beat segment included in the first section of the ECG signal corresponds to, and the second artificial neural network may estimate which of the classes representing the second type of arrhythmia the first section of the ECG signal corresponds to. According to one embodiment of the invention, like the first artificial neural network, the second artificial neural network comprises an input layer, a hidden layer, and an output layer, and may be implemented as, but is not necessarily limited to, a convolutional neural network (CNN), a recurrent neural network (RNN), or the like.

Next, the verification unit according to one embodiment of the invention may function to mutually verify the estimated class corresponding to the beat segment included in the first section of the ECG signal and the estimated class corresponding to the first section of the ECG signal.

According to one embodiment of the invention, there may be a case where the estimated class corresponding to the beat segment included in the first section of the ECG signal and the estimated class corresponding to the first section of the ECG signal are incompatible with each other. For example, there may be a case where the class corresponding to the first section of the ECG signal is estimated to be the class representing AFib and the class corresponding to the beat segment included in the first section of the ECG signal is estimated to be the class representing APC, even though APC cannot be present in the section of the ECG signal in which AFib occurs. Like the above case, the class estimation for the first section of the ECG signal or the beat segment included in the first section of the ECG signal may be incorrect, and the present invention may address such errors through a mutual verification process.

Specifically, the verification unit according to one embodiment of the invention may mutually verify the estimated class corresponding to the beat segment included in the first section of the ECG signal and the estimated class corresponding to the first section of the ECG signal, and may correct one of the estimated class corresponding to the beat segment included in the first section of the ECG signal and the estimated class corresponding to the first section of the ECG signal on the basis of the other, if it is determined from a result of the verification that the class estimation for either the beat segment included in the first section of the ECG signal or the first section of the ECG signal is incorrect (i.e., the estimated class corresponding to the beat segment included in the first section of the ECG signal and the estimated class corresponding to the first section of the ECG signal are incompatible with each other).

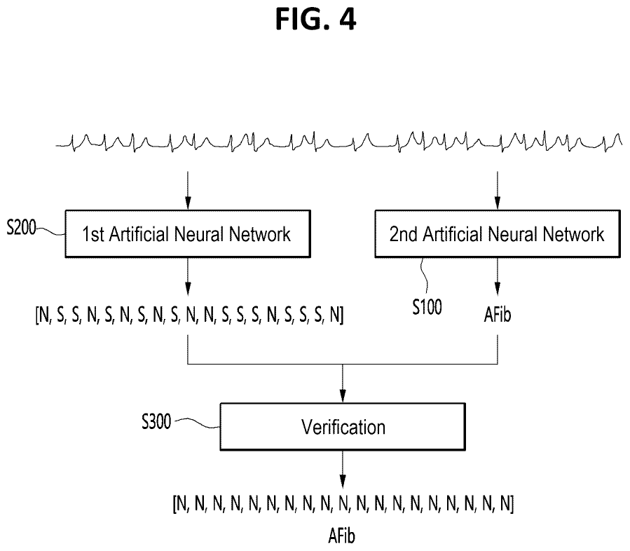

FIG. 4 illustratively shows how to estimate arrhythmia using a composite artificial neural network according to the fourth embodiment of the invention.

For example, as shown in FIG. 4, assuming that the second artificial neural network estimates the class corresponding to the first section of the ECG signal is the class representing AFib (S100), and that the first artificial neural network estimates each of the classes corresponding to 11 beat segments among 19 beat segments included in the first section of the ECG signal is the class representing APC (labeled “S”) and each of the classes corresponding to 8 beat segments among the 19 beat segments is the class representing a normal ECG (labeled “N”) (S200), the verification unit may correct the estimated class corresponding to the 11 beat segments (i.e., the class representing APC) to the class representing a normal ECG (i.e., S->N), on the basis of the estimated class corresponding to the first section of the ECG signal (i.e., the class representing AFib) (S300).

Next, the communication unit according to one embodiment of the invention may function to enable data transmission/reception from/to the first estimation unit, the second estimation unit, and the verification unit.

Lastly, the control unit according to one embodiment of the invention may function to control data flow among of the first estimation unit, the second estimation unit, the verification unit, and the communication unit. That is, the control unit according to the invention may control data flow into/out of the server 300 or data flow among the respective components of the server 300, such that the first estimation unit, the second estimation unit, the verification unit, and the communication unit may carry out their particular functions, respectively.

### Fifth Embodiment

Hereinafter, the internal configuration of the biosignal measurement device 200 according to a fifth embodiment of the invention and the functions of the respective components thereof will be discussed.

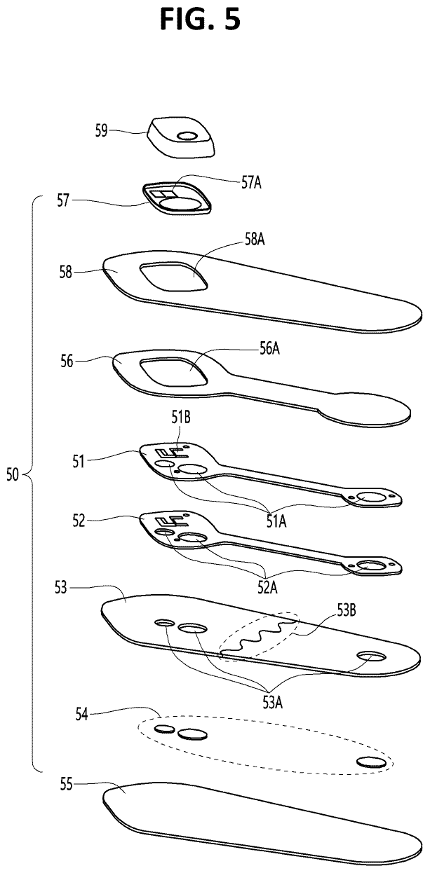

FIG. 5 illustratively shows an exploded perspective view of a biosignal measurement device 5 according to the fifth embodiment of the invention.

Referring to FIG. 5, the device 5 according to one embodiment of the invention may include an electrode assembly 50 and a body housing 59. Here, the electrode assembly 50 according to one embodiment of the invention may include a support 51, an attachment part 52, a first cover layer 53, an attachment pad 54, a second cover layer 55, a waterproof layer 56, a receiving part 57, and a third cover layer 58. In the following, the detailed components of the electrode assembly 50 will be discussed, and then the body housing 59 will be discussed.

First, the support 51 according to one embodiment of the invention may comprise an electrode 51A, a first connection member 51B, and a trace (not shown) electrically connecting the electrode 51A and the first connection member 51B. According to one embodiment of the invention, at least two electrodes 51A (preferably three electrodes including a reference electrode) may be formed in the support 51 at predetermined intervals. According to one embodiment of the invention, the electrode 51A may form a point of contact with a patient's body to measure a biosignal such as an electrocardiogram signal, and the biosignal measured from the electrode 51A may be transmitted to the first connection member 51B via the trace. Meanwhile, the support 51 according to one embodiment of the invention may be formed of a flexible material, such that the electrode 51A may easily form the point of contact with the patient's body.

Next, the attachment part 52 according to one embodiment of the invention may be formed on the lower surface of the support 51. According to one embodiment of the invention, the attachment part 52 may be formed of a material such as double-sided tape, such that one surface thereof may be attached to the lower surface of the support 51 and the other surface may be attached to the patient's body (but may be attached to the first cover layer 53 to be described later before the device 5 starts monitoring the patient's biosignal). That is, according to one embodiment of the invention, the other surface of the attachment part 52 may be an attachment surface that allows the device 5 to be attached to the patient's body.

Meanwhile, according to one embodiment of the invention, the attachment part 52 may have a first hole 52A formed in a position corresponding to the electrode 51A formed in the support 51. Here, the number of the first hole(s) 52A may correspond to the number of the electrode(s) 51A formed in the support 51, and the size or shape thereof may also correspond to the size or shape of the electrode(s) 51A.

Next, the first cover layer 53 according to one embodiment of the invention may be configured to cover the lower surface of the attachment part 52, i.e., the attachment surface. That is, the first cover layer 53 according to one embodiment of the invention may be configured to cover the attachment surface before the device 5 starts monitoring the patient's biosignal (i.e., before the attachment surface is attached to the patient's body), thereby preventing attachment strength of the attachment surface from deteriorating. Meanwhile, according to one embodiment of the invention, no adhesive materials may be formed on both the surface of the first cover layer 53 in contact with the attachment part 52 (or the upper surface of the first cover layer 53) and the surface of the first cover layer 53 not in contact with the attachment part 52 (or the lower surface of the first cover layer 53).

Meanwhile, according to one embodiment of the invention, the first cover layer 53 may have a second hole 53A formed in a position corresponding to the first hole 52A formed in the attachment part 52 (or the electrode 51A formed in the support 51). Here, the number of the second hole(s) 53A may correspond to the number of the first hole(s) 52A formed in the attachment part 52 (or the number of the electrode(s) 51A formed in the support 51), and the size or shape thereof may also correspond to the size or shape of the first hole(s) 52A (or the size or shape of the electrode(s) 51A).

Meanwhile, according to one embodiment of the invention, an incision 53B may be formed at one side of the first cover layer 53, such that the first cover layer 53 may be easily removed from the attachment part 52. According to one embodiment of the invention, the incision 53B may be formed across the first cover layer 53 to allow the first cover layer 53 to be separated into a plurality of pieces.

Next, the attachment pad 54 according to one embodiment of the invention may be electrically connected to the electrode 51A via (or by being inserted into) the first hole 52A and the second hole 53A. That is, the attachment pad 54 according to one embodiment of the invention may assist the electrode 51A in measuring the patient's biosignal by forming a point of contact with the patient's body in place of the electrode 51A. Here, the number of the attachment pad(s) 54 may correspond to the number of the electrode(s) 51A, and the size or shape thereof may correspond to the size or shape of the electrode(s) 51A (or the size or shape of the first hole(s) 52A and the second hole(s) 53A).

Next, the second cover layer 55 according to one embodiment of the invention may be configured to cover a part of the first cover layer 53 where the attachment pad 54 is exposed. According to one embodiment of the invention, the attachment pad 54 may be exposed to the outside via the second hole 53A formed in the first cover layer 53, and the second cover layer 55 may be configured to cover the second hole 53A to prevent the attachment pad 54 from being exposed to the outside before the device 5 starts monitoring the patient's biosignal (or before a location where the device 5 is attached to the patient's body is selected). Here, according to one embodiment of the invention, a release material may be formed on the surface of the second cover layer 55 in contact with the first cover layer 53 (i.e., the upper surface of the second cover layer 55), such that the second cover layer 55 may be attached to the attachment pad 54 before the device 5 starts monitoring the patient's biosignal, and may be removed from the attachment pad 54 just before the device 5 starts monitoring the patient's biosignal (or at a time when it is required to select the location where the device 5 is attached to the patient's body). Meanwhile, according to one embodiment of the invention, the surface of the second cover layer 55 not in contact with the first cover layer 53 (i.e., the lower surface of the second cover layer 55) serves as the lower surface of the device 5 before the device 5 starts monitoring the patient's biosignal, and no adhesive material may be formed thereon.

Next, the waterproof layer 56 according to one embodiment of the invention may be disposed on top of the support 51. Specifically, the waterproof layer 56 according to one embodiment of the invention may is formed of a waterproof material, and may be formed to cover the upper surface of the support 51 with a perimeter greater than the perimeter of the support 51. That is, the waterproof layer 56 according to one embodiment of the invention may block moisture, dust, and the like from entering the electrode 51A formed in the support 51.

Meanwhile, according to one embodiment of the invention, the waterproof layer 56 may have a third hole 56A formed at one side thereof, which allows the first connection member 51B to be exposed on the upper surface of the support 51. According to one embodiment of the invention, the size or shape of the third hole 56A may correspond to the size or shape of the receiving part 57 to be described below.

Next, the receiving part 57 according to one embodiment of the invention may be fixedly coupled to the support 51 via the third hole 56A formed in the waterproof layer 56. Further, the receiving part 57 according to one embodiment of the invention may have a fourth hole 57A formed in a position corresponding to the first connection member 51B (or a position corresponding to the third hole 56A formed in the waterproof layer 56), such that the first connection member 51B may be exposed on the upper surface of the support 51.

Meanwhile, the receiving part 57 according to one embodiment of the invention may have a fixing member (not shown) formed at one side thereof, which is configured to fix the body housing 59. For example, the fixing member may be formed along an inner perimeter of the receiving part 57, and may form a snag structure (or snap fit structure) together with a fixing member (not shown) formed along an outer perimeter of the body housing 59. According to one embodiment of the invention, the snag structure may allow the body housing 59 to be detachably received in (or coupled to) the receiving part 57.

Next, the third cover layer 58 according to one embodiment of the invention may be configured to cover the waterproof layer 56. According to one embodiment of the invention, the third cover layer 58 may be configured to cover the waterproof layer 56 to prevent the waterproof layer 56 from being exposed to the outside before the device 5 starts monitoring the patient's biosignal. According to one embodiment of the invention, the third cover layer 58 may have a fifth hole 58A formed in a shape corresponding to the perimeter of the receiving part 57, such that the third cover layer 58 may be detached from the waterproof layer 56 and then removed as the receiving part 57 (or the receiving part 57 and the body housing 59 coupled to the receiving part 57) pass through the fifth hole 58A.

Next, the body housing 59 according to one embodiment of the invention may include components for managing the biosignal measured through the electrode 51A formed in the support 51. According to one embodiment of the invention, the body housing 59 may have a second connection member (not shown) formed at one side thereof (e.g., on the lower surface of the body housing 59), which may be mounted on a printed circuit board assembly (PCBA) disposed within the body housing 59. According to one embodiment of the invention, the second connection member may be electrically connected to the first connection member 51B via the third hole 56A and the fourth hole 57A, and may receive the biosignal measured through the electrode 51A from the first connection member 51B. Meanwhile, according to one embodiment of the invention, in addition to the second connection member, a memory for recording the biosignal, a processor for processing the biosignal (e.g., estimating arrhythmia from the biosignal if the biosignal is an electrocardiogram signal), a communication module for transmitting the biosignal to the outside (via wired or wireless transmission), and the like may be further mounted on the PCBA disposed within the body housing 59.

Meanwhile, the body housing 59 according to one embodiment of the invention may have a fixing member (not shown) formed at one side thereof as described above, which may form a snag structure (or snap fit structure) together with the fixing member formed in the receiving part 57, such that the body housing 59 may be detachably coupled to the receiving part 57 as the body housing 59 is received in the receiving part 57. According to one embodiment of the invention, since the body housing 59 is detachably coupled to the receiving part 57, the electrode assembly 50 may be easily replaced with another electrode assembly 50 by detaching the body housing 59 from the receiving part 57 when an unintended deterioration of attachment strength of the attachment surface occurs while the device 5 monitors the biosignal. This allows biosignal data stored in the memory within the body housing 59 to be preserved, while allowing the biosignal measurement to continue as long as the monitoring is required.

Meanwhile, in the following, how to attach the device 5 to a user's body according to the fifth embodiment of the invention will be discussed in detail, focusing on the first cover layer 53 and the second cover layer 55 among the components included in the device 5.

According to one embodiment of the invention, the device 5 may be delivered to a patient in a state in which the electrode assembly 50 and the body housing 59 are coupled and the respective components of the electrode assembly 50 are coupled.

First, according to one embodiment of the invention, the second cover layer 55 disposed at the lowermost part of the device 5 is removed from the device 5. According to one embodiment of the invention, in a state in which the second cover layer 55 is removed from the device 5, only the first cover layer 53 and the attachment pad 54 are exposed at the lower part of the device 5. Here, since no adhesive material is formed on the lower surface of the first cover layer 53, the device 5 will not be attached to the patient's body even if the device 5 is in contact with the patient's body in this state.

Next, according to one embodiment of the invention, in a state in which the first cover layer 53 and the attachment pad 54 are exposed at the lower part of the device 5, the device 5 is placed at various locations on the patient's body to observe the patient's biosignal, and the location where the biosignal is most clearly measured is selected. Further, the selected location is indicated by a marker.

Next, according to one embodiment of the invention, the device 5 is removed from the patient's body and the first cover layer 53 is removed from the device 5. According to one embodiment of the invention, in a state in which the first cover layer 53 is removed from the device 5, only the attachment part 52 and the attachment pad 54 may be exposed at the lower part of the device 5.

Next, according to one embodiment of the invention, in a state in which the attachment part 52 and the attachment pad 54 are exposed at the lower part of the device 5, the lower surface of the attachment part 52, i.e., the attachment surface is attached to the location indicated by the marker.

Lastly, according to one embodiment of the invention, in a state in which the attachment surface is attached to the patient's body (i.e., the location indicated by the marker), the third cover layer 58 is removed from the device 5.

Thus, the present invention may minimize deterioration of attachment strength of the attachment surface that may occur during the process of selecting an attachment location for the device 5, and select an optimal location for clear biosignal measurement on the patient's body.

### Sixth Embodiment

Hereinafter, the internal configuration of the server 300 according to a sixth embodiment of the invention and the functions of the respective components thereof will be discussed.

The server 300 according to one embodiment of the invention may comprise a feature extraction unit, a clustering management unit, a communication unit, and a control unit. According to one embodiment of the invention, at least some of the feature extraction unit, the clustering management unit, the communication unit, and the control unit of the server 300 may be program modules to communicate with an external system (not shown). The program modules may be included in the server 300 in the form of operating systems, application program modules, and other program modules, while they may be physically stored in a variety of commonly known storage devices. Further, the program modules may also be stored in a remote storage device that may communicate with the server 300. Meanwhile, such program modules may include, but are not limited to, routines, subroutines, programs, objects, components, data structures and the like for performing specific tasks or executing specific abstract data types as will be described below in accordance with the invention.

Meanwhile, the above description is illustrative although the server 300 has been described as above, and it will be apparent to those skilled in the art that at least a part of the components or functions of the server 300 may be implemented in the viewing/editing device 600 or included in an external system (not shown), as necessary.

First, the feature extraction unit according to one embodiment of the invention may acquire a plurality of pieces of biosignal data measured from a subject's body. Here, the biosignal data may be electrocardiogram (ECG) signal data measured from the subject's body, and the ECG signal data may be composed of beat units that include QRS complexes.

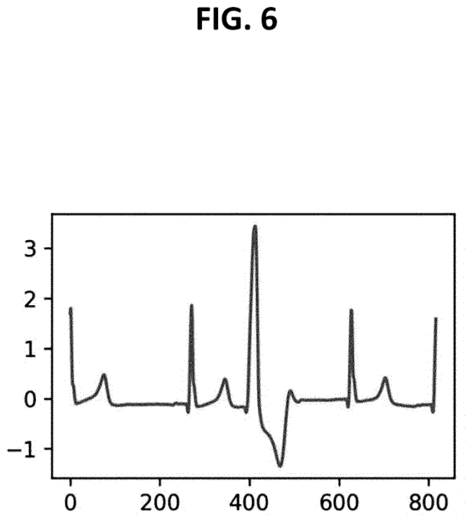

For example, the ECG signal data to be clustered may be composed of a sequence of five beats, and an interval from an R peak of the first beat to an R peak of the last beat may be defined as one piece of ECG signal data (see FIG. 6).

Further, the feature extraction unit according to one embodiment of the invention may extract features from a plurality of pieces of biosignal data for a biosignal, and generate a plurality of feature vectors for the plurality of pieces of biosignal data, respectively, on the basis of the extracted features.

For example, the feature extraction unit according to one embodiment of the invention may extract the features from the biometric signal data using a feature extraction model trained through supervised learning.

According to one embodiment of the invention, significant changes in signal values appear in QRS complexes included in an ECG signal, and thus when clustering is performed with respect to raw data of the biosignal data, there may occur a problem that the clustering is not properly performed due to beat position differences, beat height differences, baseline variations, noises, and the like. According to the invention, features are extracted from the raw data to generate feature vectors and clustering is performed with respect to the feature vectors, so that it is possible to reduce the problem that may occur when the clustering is performed with respect to the raw data.

Further, the feature extraction unit according to one embodiment of the invention may normalize a plurality of pieces of raw data and extract features from the normalized data. This allows the length of the clustered data to be identical (or uniform) even when the length of the raw data varies due to various factors such as heart rate.

In addition, the feature extraction unit according to one embodiment of the invention may extract features from a plurality of pieces of raw data using a feature extraction model, and the plurality of pieces of raw data may be normalized according to the method described above and inputted to the feature extraction model. For example, the feature extraction model may be a model obtained by optimizing a squeeze & excitation (SE) ResNet model according to the objects of the invention.

Meanwhile, the feature extraction unit according to one embodiment of the invention may extract scaled R-R intervals that reflect the characteristics of rhythm between beats within a plurality of pieces of raw data for an ECG signal, and the extracted scaled R-R intervals may be used as a criterion for clustering to be described below.

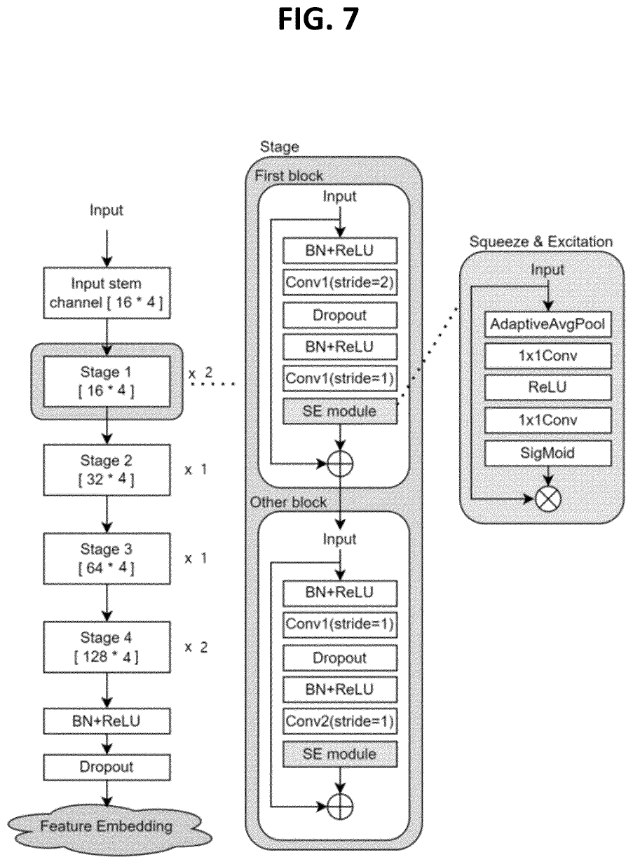

FIG. 7 illustratively shows the structure of a model used for feature extraction according to the sixth embodiment of the invention. However, it is noted that the feature extraction unit according to the invention is not necessarily implemented on the basis of the model shown in FIG. 7, but may be changed without limitation as long as the objects of the invention may be achieved.

Next, the clustering management unit according to one embodiment of the invention may acquire analysis result data for a plurality of pieces of biosignal data from a biosignal analysis model. According to one embodiment of the invention, the biosignal analysis model may be a model that outputs an analysis result regarding whether the analyzed biosignal data corresponds to arrhythmia, or an analysis result regarding what type of arrhythmia the analyzed biosignal data corresponds to.

For example, according to one embodiment of the invention, the biosignal analysis model may analyze biosignal data of a subject using a machine learning algorithm (e.g., an artificial neural network) to calculate a score regarding whether the biosignal data corresponds to (or does not correspond to) a normal state in terms of arrhythmia.

As another example, according to one embodiment of the invention, the biosignal analysis model may analyze biosignal data of a subject using a machine learning algorithm (e.g., an artificial neural network) to calculate a score regarding whether the biosignal data corresponds to (or does not correspond to) a specific type of arrhythmia.

Here, according to one embodiment of the invention, the score calculated by the biosignal analysis model may encompass a value for at least one of a probability, a vector, a matrix, and a coordinate regarding correspondence (or non-correspondence) to a normal state or a specific type of arrhythmia.

Meanwhile, the biosignal that may be analyzed by the biosignal analysis model may include a signal regarding an electrocardiogram (ECG), an electromyogram (EMG), an electroencephalogram (EEG), a photoplethysmogram (PPG), a heartbeat, a body temperature, a blood sugar level, a pupil change, a blood pressure level, a blood oxygen content, and the like.

Next, the clustering management unit according to one embodiment of the invention may perform clustering on a plurality of pieces of first-type biosignal data analyzed as corresponding to a first type by the biosignal analysis model, among the plurality of pieces of biosignal data.

Here, according to one embodiment of the invention, the first type refers to, in its broadest sense, a type that may be determined by the biosignal analysis model, and may encompass a normal state in terms of arrhythmia, an abnormal state in terms of arrhythmia, and a state corresponding to a specific type of arrhythmia (e.g., atrial premature complexes (APCs), ventricular premature complexes (VPCs), atrial fibrillation (AFib), and paroxysmal supra ventricular tachycardia (PSVT)).

Specifically, the clustering management unit according to one embodiment of the invention may cluster a plurality of pieces of first-type biosignal data analyzed as corresponding to the first type into at least one cluster. According to one embodiment of the invention, the biosignal data clustered into the same cluster as the clustering is performed may have features (e.g., patterns, feature points, or waveforms) that are common to each other.

For example, the algorithm that may be used for the biosignal data clustering according to one embodiment of the invention may include complete linkage clustering, k-means, mean shift, Gaussian mixture model (GMM), density-based spatial clustering of applications with noise (DBSCAN), and self-organizing map (SOM). However, it is noted that the clustering algorithm according to the invention is not necessarily limited to those listed above but may be changed without limitation as long as the objects of the invention may be achieved.

In addition, the clustering management unit according to one embodiment of the invention may perform clustering on the plurality of extracted feature vectors.

Further, the clustering management unit according to one embodiment of the invention may perform clustering on the plurality of pieces of biosignal data corresponding to the plurality of feature vectors, with reference to the plurality of feature vectors.

For example, the biosignal data (or the plurality of pieces of raw data) according to one embodiment of the invention may include data classified as APCs or data classified as VPCs, and the clustering management unit according to one embodiment of the invention may perform clustering on the data classified as APCs and clustering on the data classified as VPCs separately.

Further, the clustering management unit according to one embodiment of the invention may perform clustering on the biosignal data using a hierarchical clustering technique. According to the hierarchical clustering technique utilized in the invention, there are advantages that the number of clusters does not need to be predetermined and structural relationships between the clusters may be easily identified. Furthermore, the hierarchical clustering may generate only the level (or number) of clusters suitable for analysis or interpretation situations, thereby preventing unnecessary clustering and further enhancing the efficiency of interpretation (or inspection).

Specifically, the clustering management unit according to one embodiment of the invention may perform the clustering with reference to a distance map between the plurality of feature vectors generated on the basis of the features extracted from the plurality of pieces of biosignal data. For example, pieces of biosignal data corresponding to certain feature vectors may be clustered to belong to different clusters as a distance between the feature vectors is longer, and may be clustered to belong to the same cluster as the distance between the feature vectors is shorter.

More specifically, the clustering management unit according to one embodiment of the invention may perform the clustering with further reference to a distance map between the plurality of pieces of raw data. For reference, the distance map between the plurality of pieces of raw data may be treated as an indicator representing differences between shapes or positions of QRS complexes included in the raw data. For example, when a distance difference between certain pieces of raw data is greater than a predetermined value (i.e., when shapes or positions of QRS complexes are different), the clustering management unit according to one embodiment of the invention may impose a predetermined penalty on a distance map between feature vectors corresponding to the pieces of raw data, thereby allowing morphological similarity between pieces of biosignal data appearing in the raw data to be reflected in the clustering.

Meanwhile, the clustering management unit according to one embodiment of the invention may perform complete linkage clustering with reference to the distance map calculated as above.

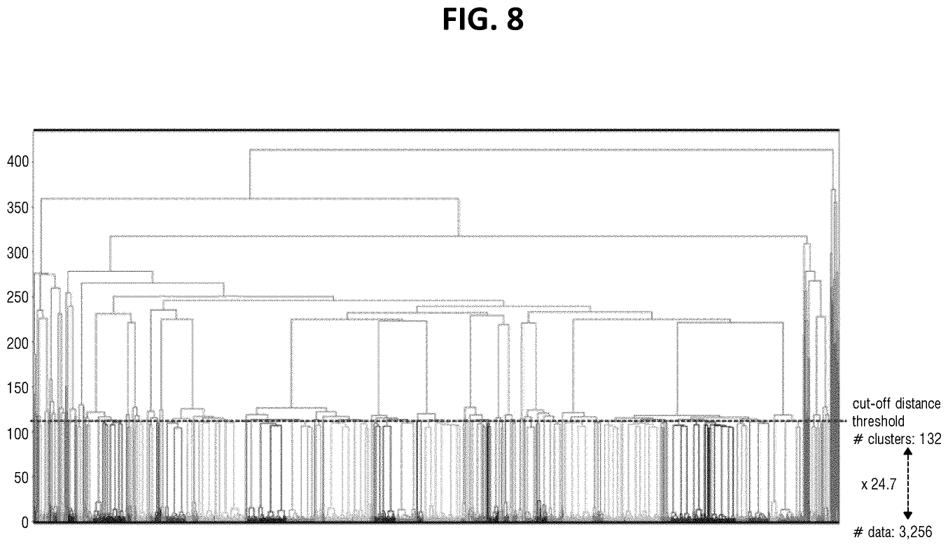

Further, the clustering management unit according to one embodiment of the invention may determine the hierarchy (or number) of clusters to be outputted as a result of the clustering, on the basis of a cut-off distance threshold determined by a ratio of the number of clusters to the total number of pieces of raw data in hierarchical clusters constructed as the result of the clustering. For example, as shown in FIG. 8, when a ratio of inspection efficiency increase due to the clustering (i.e., the total number of pieces of raw data/the number of clusters) should be 20 times or more and the total number of pieces of raw data is 3,256, a hierarchy that generates a total of 132 clusters may be determined as an output hierarchy, thereby achieving an inspection efficiency increase ratio of 24.7.

That is, when a ratio of inspection efficiency increase due to the clustering is 20, a medical worker (or inspector) only needs to inspect one cluster including twenty pieces of ECG signal data instead of inspecting each of the twenty pieces of ECG signal data individually, so that the inspection efficiency may be increased by about 20 times due to the clustering according to the invention.

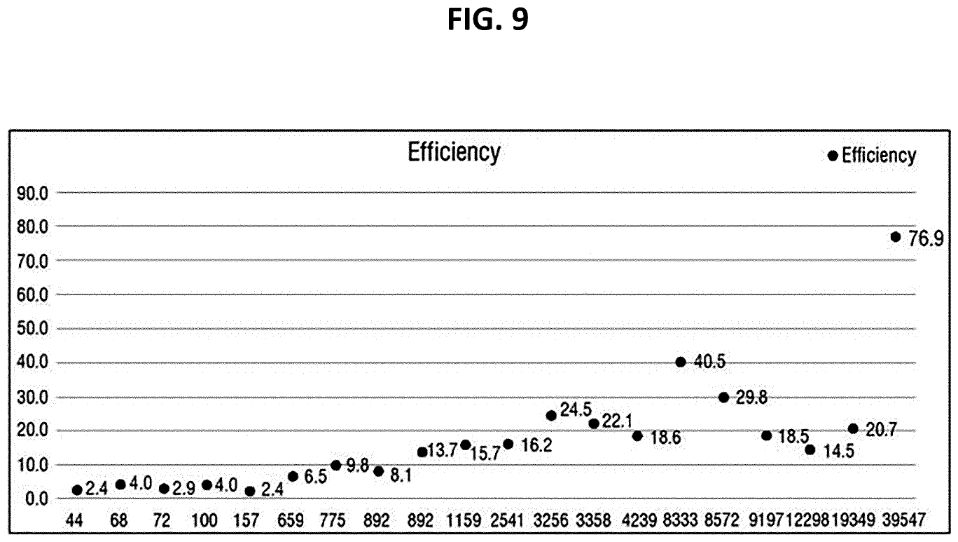

Meanwhile, FIG. 9 illustratively shows a degree to which interpretation efficiency of an inspector increases as clustering is performed according to the sixth embodiment of the invention. Referring to FIG. 9, it can be seen that a ratio of inspection efficiency increase (shown on the vertical axis of FIG. 9) due to the clustering is greater as there are more pieces of clustered biosignal data (shown on the horizontal axis of FIG. 9).

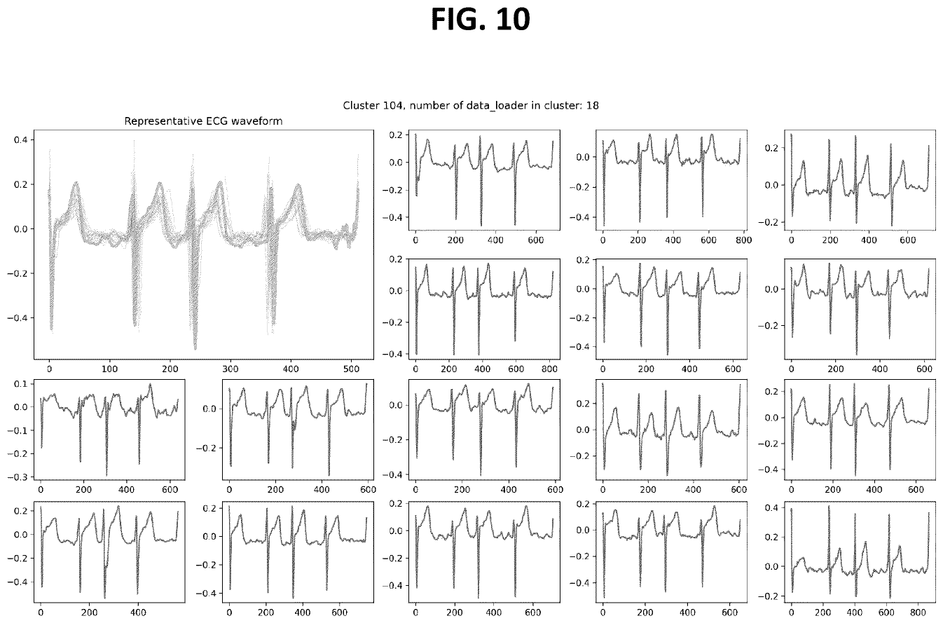

Meanwhile, FIGS. 10 to 13 illustratively show the results of performing clustering on ECG signal data according to the sixth embodiment of the invention.

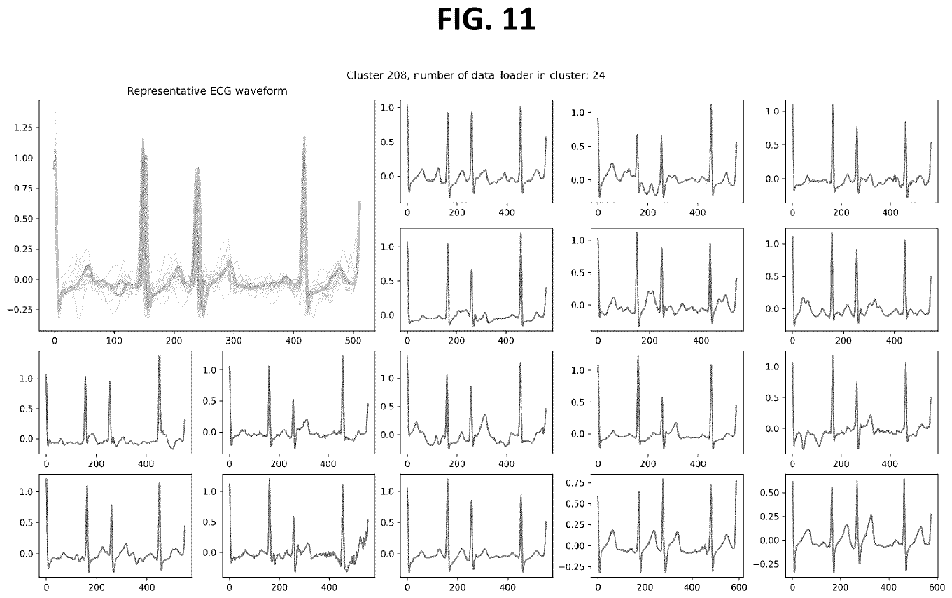

Referring to FIGS. 10 and 11, a result is shown in which 18 pieces of ECG signal data classified as APCs are clustered into one cluster (see FIG. 10), and a result is shown in which 24 pieces of ECG signal data classified as APCs are clustered into one cluster (see FIG. 11).

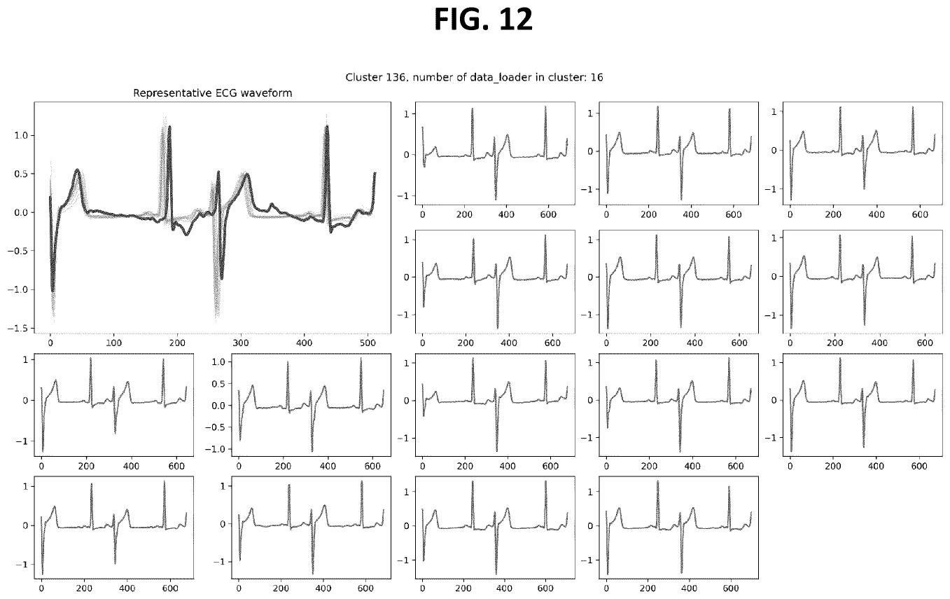

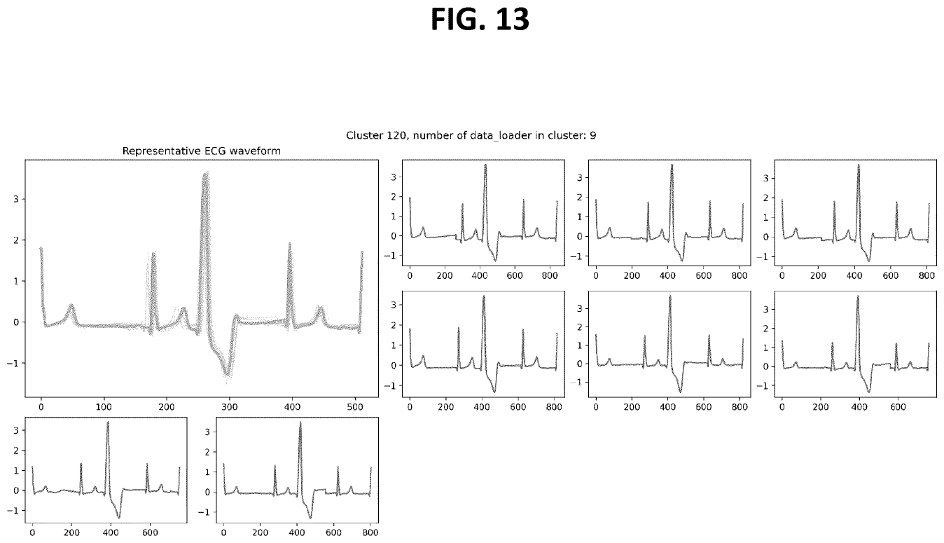

Referring to FIGS. 12 and 13, a result is shown in which 16 pieces of ECG signal data classified as VPCs are clustered into one cluster (see FIG. 12), and a result is shown in which 9 pieces of ECG signal data classified as VPCs are clustered into one cluster (see FIG. 13).

Next, the communication unit according to one embodiment of the invention may function to enable data transmission/reception from/to the feature extraction unit and the clustering management unit.

Lastly, the control unit according to one embodiment of the invention may function to control data flow among of the feature extraction unit, the clustering management unit, and the communication unit. That is, the control unit according to the invention may control data flow into/out of the server 300 or data flow among the respective components of the server 300, such that the feature extraction unit, the clustering management unit, and the communication unit may carry out their particular functions, respectively.

Although the embodiments for analyzing ECG signal data have been mainly described above, it is noted that the signal that may be analyzed according to the invention is not necessarily limited only to an ECG signal, but the present invention may be utilized for other types of biosignals without limitation, as long as the objects of the invention may be achieved.

### Seventh Embodiment

Hereinafter, the internal configuration of the biosignal measurement device according to a seventh embodiment of the invention and the functions of the respective components thereof will be discussed.

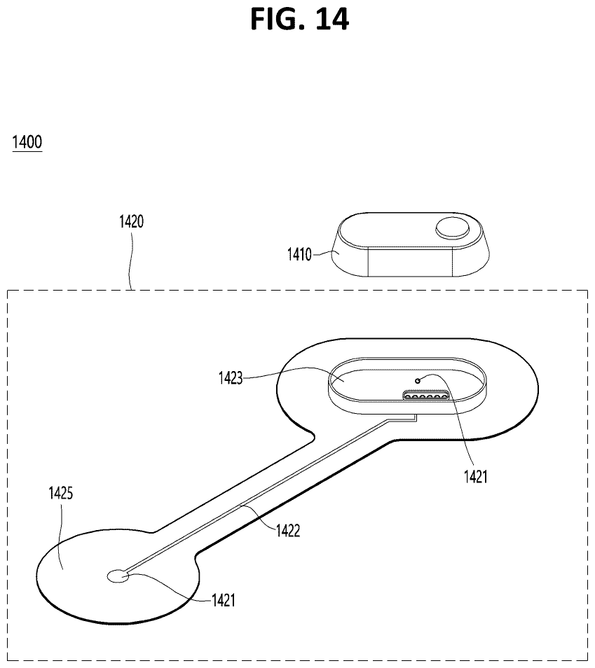

FIGS. 14 to 16 illustratively show a main body unit and an electrode unit according to the seventh embodiment of the invention.

Referring to FIG. 14, a biosignal measurement device 1400 according to one embodiment of the invention may comprise a main body unit 1410 and an electrode unit 1420. Here, the electrode unit 1420 according to one embodiment of the invention may include two or more electrodes 1421, a circuit unit 1422, and a pad 1425. In the following, the detailed components of the electrode unit 1420 will be discussed, and then the main body unit 1410 will be discussed.

First, the electrode unit 1420 according to one embodiment of the invention may include two or more electrodes 1421 for acquiring a biosignal. Here, according to one embodiment of the invention, at least two electrodes 1421 may be formed at a predetermined interval, and three electrodes including a reference electrode may preferably be formed. According to one embodiment of the invention, the electrodes 1421 may form contact points with a patient's body to acquire a biosignal such as an electrocardiogram (ECG) signal, and the biosignal acquired from the electrodes 1421 may be transmitted to the main body unit 1410 through the circuit unit 1422. For example, one of the two or more electrodes according to one embodiment of the invention may be formed at the bottom of a coupling unit 1423 to acquire a biosignal.

Further, the electrode unit 1420 according to one embodiment of the invention may include a circuit unit 1422 for electrically connecting the electrodes 1421 and the main body unit 1410. Here, referring to FIG. 14, the circuit unit 1422 according to one embodiment of the invention may include a circuit trace for transmitting the biosignal acquired from the electrodes 1421 to the main body unit 1410.

Furthermore, the electrode unit 1420 according to one embodiment of the invention may include a pad 1425. The pad 1425 according to one embodiment of the invention may be arranged around the electrodes 1421, and the electrodes 1421 may form contact points with the patient's body when the pad 1425 is attached to the patient, so that the electrodes 1421 may acquire a biosignal. Here, the pad 1425 according to one embodiment of the invention may include an attachment pad that is electrically connected to the circuit unit 1422 and attached at a position appropriate for acquiring the patient's biosignal, and double-sided tape for attaching to the patient. For example, the biosignal according to one embodiment of the invention may be acquired by the electrodes 1421 from the patient's body that is in contact with the attachment pad. Therefore, the pad 1425 according to one embodiment of the invention may function to attach to the patient so that a biosignal may be acquired from the electrodes 1421. Meanwhile, the attachment pad according to one embodiment of the invention may function to assist the electrodes 1421 in acquiring the patient's biosignal by forming a contact point with the patient's body instead of the electrodes 1421.

In addition, the coupling unit 1423 according to one embodiment of the invention may function to allow the main body unit 1410 and the electrode unit 1420 to be detachably coupled. When the main body unit 1410 and the electrode unit 1420 are coupled by the coupling unit 1423 according to one embodiment of the invention, the biosignal acquired from the electrode unit 1420 may be transmitted to the main body unit 1410, so that the main body unit 1410 may store the biosignal.

Moreover, the biosignal according to one embodiment of the invention may include an electrocardiogram (ECG) signal. However, the biosignal according to the invention is not limited to an ECG signal, and may include various biosignals (e.g., blood oxygen saturation, heart rate, or body temperature) as long as the objects of the invention may be achieved.

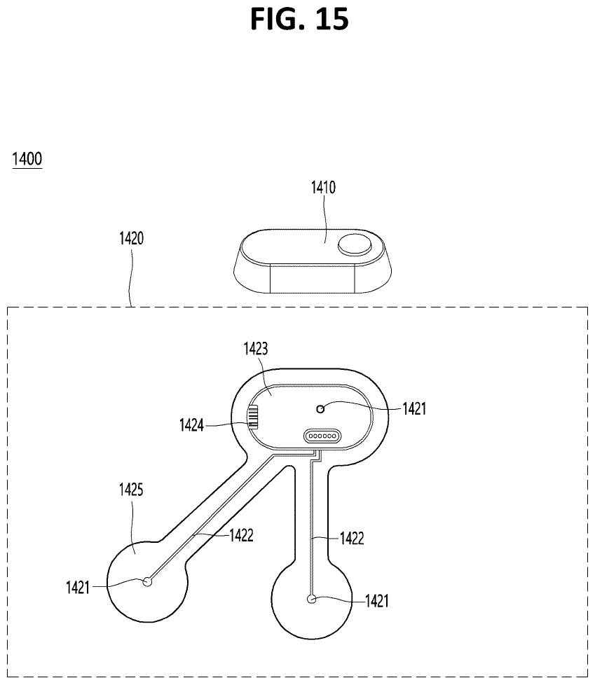

Referring to FIG. 15, for example, the electrode unit 1420 according to one embodiment of the invention may include three electrodes. Here, referring to FIG. 15, one electrode may be arranged at the bottom of the coupling unit 1423, and the other two electrodes may be arranged at appropriate positions for acquiring an ECG signal. Here, a channel according to one embodiment of the invention may be defined by one electrode (i.e., one unipolar electrode) using a Wilson central terminal (WCT) or two electrodes (i.e., a pair of electrodes), and when the electrode unit 1420 includes three electrodes (e.g., electrodes arranged at positions associated with RA (Right Atrium), LA (Left Atrium), and LL (Left Leg) of 12 ECG leads in the chest area), biosignals related to two channels (i.e., a channel associated with the direction from RA to LA and a channel associated with the direction from RA to LL) may be acquired. Further, the channel according to one embodiment of the invention may be defined as a lead specified by two electrodes.

Meanwhile, it should be understood that one of the electrodes 1421 according to the invention does not necessarily have to be arranged at the bottom of the coupling unit 1423, but may be arranged at various points for achieving the objects of the invention.

An extension connection unit 1424 may be further formed in the electrode unit 1420 according to one embodiment of the invention. Specifically, an extension connection unit 1424 electrically connected to the electrode unit 1420 may be further formed in the electrode unit 1420, and additional electrodes for acquiring the biosignal may be connected to the extension connection unit 1424.

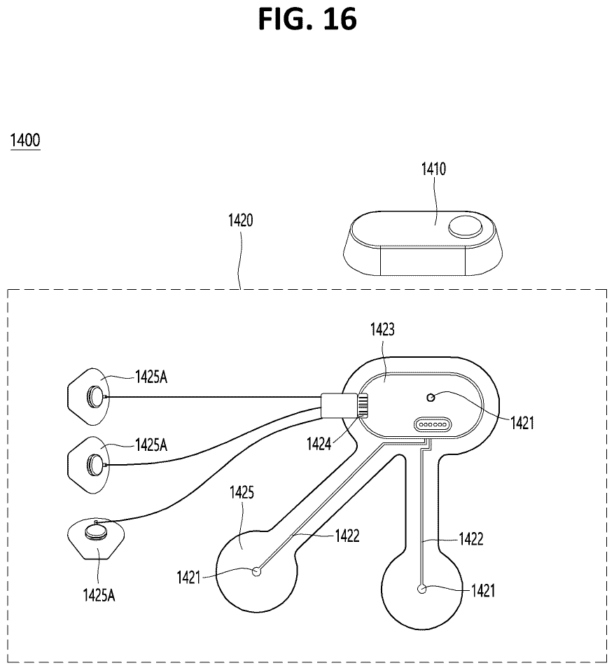

Referring to FIG. 16, additional electrodes for acquiring a biosignal may be connected to the extension connection unit 1424 according to one embodiment of the invention, in which case the additional electrodes may be electrically connected to the extension connection unit through the circuit unit 1422. Here, in order to acquire a biosignal from the additional electrodes, additional pads 1425A may be arranged around the additional electrodes according to one embodiment of the invention, and the additional pads 1425A may form contact points with the patient's body to acquire the biosignal. For example, when the biosignal according to one embodiment of the invention is an ECG signal, the additional electrodes may be arranged at at least one position among V1, V2, V3, V4, V5, and V6 of the patient among 12 ECG leads, which are known to be appropriate for ECG signal acquisition, to acquire the ECG signal. In this case, it is possible to acquire the ECG signal in more diverse ways, so that the electrocardiogram signal is multilaterally identified and the patient's heart disease is accurately identified.

Next, the main body unit 1410 according to one embodiment of the invention may include various components for operating the device 1400, such as a battery, a printed circuit board assembly (PCBA), and a memory for storing the biosignal.

The main body unit 1410 according to one embodiment of the invention may function to acquire unique information of the electrode unit 1420 in response to being coupled to the electrode unit 1420. Here, the unique information according to one embodiment of the invention may include information on the number or arrangement of the electrodes. For example, when the main body unit 1410 and the electrode unit 1420 according to one embodiment of the invention are coupled and the electrode unit 1420 includes three electrodes 1421, the unique information may include at least one of information indicating that the electrode unit 1420 includes three electrodes and information indicating that the electrodes are arranged at positions associated with RA, LA, and LL, respectively.

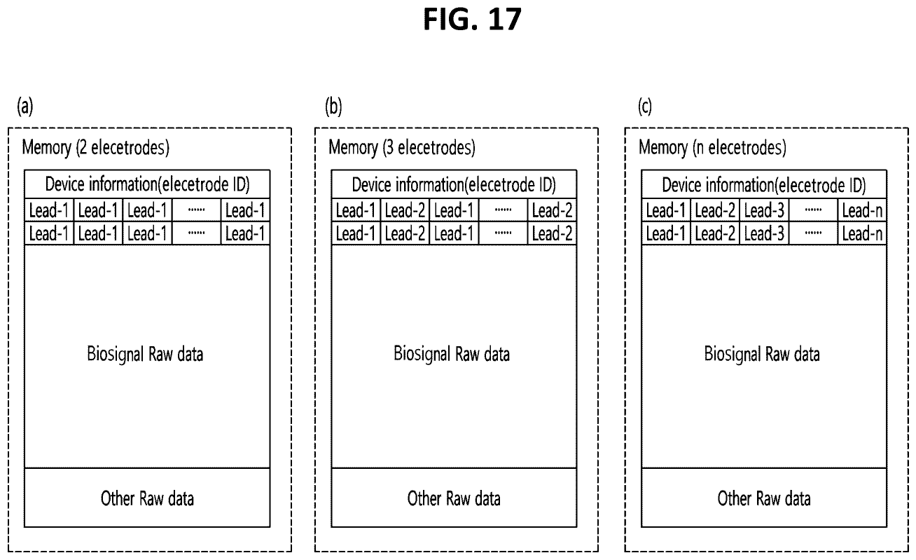

FIG. 17 illustratively shows a situation in which a biosignal is stored separately for each channel according to the seventh embodiment of the invention.

Referring to FIG. 17, the main body unit 1410 according to one embodiment of the invention may function to specify at least one channel implemented by the electrode unit 1420 coupled to the main body unit 1410, and store a biosignal acquired through the electrode unit 1420 separately for each channel.

For example, referring to (a) of FIG. 17, when the electrode unit 1420 according to one embodiment of the invention includes two electrodes respectively arranged at positions associated with RA and LL, there may be one channel implemented by the electrode unit 1420, so that a single channel ECG signal may be acquired. Here, according to one embodiment of the invention, when the main body unit 1410 and the electrode unit 1420 are coupled, the main body unit 1410 may acquire unique information indicating that the electrode unit 1420 has two electrodes and the electrodes are arranged at positions associated with RA and LL, and the main body unit may store the single channel ECG signal.

Further, for example, referring to (b) of FIG. 17, when the electrode unit 1420 according to one embodiment of the invention includes three electrodes respectively arranged at positions associated with RA, LA, and LL, and the main body unit 1410 and the electrode unit 1420 are coupled, the main body unit 1410 may acquire unique information indicating that the electrode unit 1420 has three electrodes and the electrodes are arranged at positions associated with RA, LA, and LL, and the main body unit may acquire biosignals from two channels (e.g., a channel associated with the direction from RA to LA and a channel associated with the direction from RA to LL).

When a single channel biosignal is stored, there is little need to separately store the biosignal since the biosignal is acquired at the same point. However, when biosignals are acquired from two channels as shown in (b) of FIG. 17, it may be difficult or impossible to monitor the acquired biosignals if the biosignals are not separated and organized. Therefore, as shown in (b) of FIG. 17, according to one embodiment of the invention, when biosignals are acquired from two channels, the main body unit 1410 may function to store the acquired biosignals separately for each of the two channels with reference to the acquired unique information (e.g., information on the number or arrangement of the electrodes). For example, the main body unit 1410 according to one embodiment of the invention may store the acquired biosignals alternately for each channel in chronological order. As a specific example, when biosignals a1, a2, and a3 are acquired sequentially from the electrodes related to the channel associated with the direction from RA to LA, and biosignals b1, b2, and b3 are acquired sequentially from the electrodes related to the channel associated with the direction from RA to LL, the main body unit 1410 according to one embodiment of the invention may store the biosignals in the order of a1, b1, a2, b2, a3, and b3. According to one embodiment of the invention, when the biosignals are stored alternately for each channel as above, the biosignals may be stored for each channel in the main body unit 1410 without undergoing separate additional processing, and the biosignals acquired from the electrodes related to various channels may be stored in a single data file, so that the structure of the device 1400 may be simplified.

As another example, referring to (c) of FIG. 17, when the electrode unit 1420 according to one embodiment of the invention includes three or more electrodes, the main body unit 1410 may acquire information on the position and arrangement of the electrodes included in the electrode unit 1420 as unique information as described above, and when biosignals are acquired, the main body unit 1410 may store the biosignals separately for each channel as described above.

Meanwhile, the biosignal according to one embodiment of the invention is stored in an encrypted form, so that personal health information may be stored safely.

Finally, when a USB terminal is coupled to the main body unit 1410 according to one embodiment of the invention and the main body unit is electrically connected to an external device (e.g., PC), the biosignal stored in the main body unit 1410 may be transmitted to the PC. In this case, the transmitted biosignal according to one embodiment of the invention may be encrypted to safely protect personal health information.

Meanwhile, it should be understood that the term “patient” as used herein encompasses not only a patient with heart disease but also a patient who wants to check whether he/she has heart disease.

### Eighth Embodiment

Hereinafter, the internal configuration of the biosignal measurement device according to an eighth embodiment of the invention and the functions of the respective components thereof will be discussed.

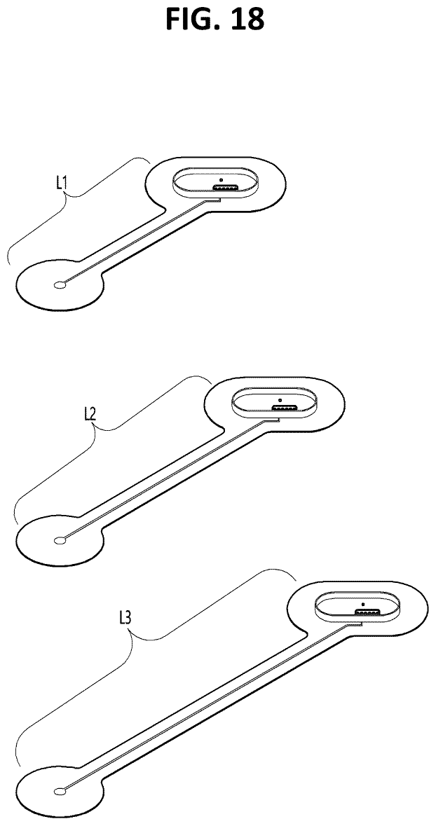

According to the eighth embodiment of the invention, an inter-electrode distance of a plurality of electrodes included in the electrode unit 1420 of the biosignal measurement device may be variously set in two or more types. Referring to FIG. 18, the electrode unit 1420 according to one embodiment of the invention may be any one of a first type (L1) electrode unit with a minimum inter-electrode distance, a second type (L2) electrode unit with an intermediate inter-electrode distance, and a third type (L3) electrode unit with a maximum inter-electrode distance. However, the type classification based on the inter-electrode distance of the electrode unit 1420 according to the invention is not necessarily limited to the foregoing but may be changed without limitation as long as the objects of the invention may be achieved. As another example, the electrode unit 1420 according to one embodiment of the invention may be classified into two types or four or more types according to the inter-electrode distance.

The main body unit 1410 according to the eighth embodiment of the invention may comprise an acquisition unit, a decision unit, a provision unit, a communication unit, and a control unit. According to one embodiment of the invention, at least some of the acquisition unit, the decision unit, the provision unit, the communication unit, and the control unit of the main body unit 1410 may be program modules to communicate with an external system (not shown). The program modules may be included in the biosignal measurement device in the form of operating systems, application program modules, and other program modules, while they may be physically stored in a variety of commonly known storage devices. Further, the program modules may also be stored in a remote storage device that may communicate with the biosignal measurement device. Meanwhile, such program modules may include, but are not limited to, routines, subroutines, programs, objects, components, data structures, and the like for performing specific tasks or executing specific abstract data types as will be described below in accordance with the invention.

Meanwhile, the above description is illustrative although the main body unit 1410 has been described as above, and it will be apparent to those skilled in the art that at least a part of the components or functions of the main body unit 1410 may be implemented in the server 300 or included in an external system (not shown), as necessary.

First, the acquisition unit according to one embodiment of the invention may acquire information on physical characteristics of a subject wearing the biosignal measurement device.

According to one embodiment of the invention, the information on the physical characteristics of the subject may include information on at least one of the subject's height, weight, and body mass index (BMI).

Specifically, according to one embodiment of the invention, the information on the physical characteristics of the subject may be inputted through a separate device (such as a smartphone held by the subject or an administrator) capable of communicating with the biosignal measurement device. When the subject or administrator inputs the information on the physical characteristics of the subject through the separate device, the information may be transmitted to the main body unit 1410 of the biosignal measurement device worn by the subject.

Further, the acquisition unit according to one embodiment of the invention may acquire information on a distance between two or more electrodes included in the electrode unit 1420 coupled to the main body unit 1410.

Specifically, according to one embodiment of the invention, the information on the distance between the two or more electrodes included in the electrode unit 1420 may be specified on the basis of unique information of the electrode unit 1420, and the unique information of the electrode unit 1420 may be acquired in response to the main body unit 1410 being coupled to the electrode unit 1420.

Next, the decision unit according to one embodiment of the invention may determine an inter-electrode distance applied to the subject with reference to the information on the physical characteristics of the subject. Here, according to one embodiment of the invention, the information on the physical characteristics of the subject may include information on at least one of the subject's height, weight, and body mass index (BMI).

Specifically, when the inter-electrode distance is classified into three types (i.e., a minimum distance, an intermediate distance, and a maximum distance), the decision unit according to one embodiment of the invention may determine the inter-electrode distance applied to the subject as one of the three types with reference to the subject's height, weight, or body mass index. For example, the three types of the inter-electrode distance, i.e., minimum distance (L1), intermediate distance (L2), and maximum distance (L3), may be set to 6 cm, 10 cm, and 12 cm, respectively.

More specifically, the decision unit according to one embodiment of the invention may determine the inter-electrode distance applied to the subject as the minimum distance (L1) if the subject's height is less than a minimum threshold, and may determine the inter-electrode distance applied to the subject as the maximum distance (L3) if the subject's height is not less than a maximum threshold. For example, the minimum and maximum thresholds for the height may be 160 cm and 185 cm, respectively.

Further, the decision unit according to one embodiment of the invention may determine the inter-electrode distance applied to the subject as the minimum distance (L1) if the subject's weight is less than a minimum threshold, and may determine the inter-electrode distance applied to the subject as the maximum distance (L3) if the subject's weight is not less than a maximum threshold. For example, the minimum and maximum thresholds for the weight may be 50 kg and 90 kg, respectively.

In addition, the decision unit according to one embodiment of the invention may determine the inter-electrode distance applied to the subject as the intermediate distance (L2) if the subject's body mass index is less than a predetermined threshold, and may determine the inter-electrode distance applied to the subject as the maximum distance (L3) if the subject's body mass index is not less than the predetermined threshold. For example, the predetermined threshold for the body mass index may be 25.

Meanwhile, the decision unit according to one embodiment of the invention may determine the inter-electrode distance applied to the subject in consideration of priority among two or more physical characteristics of the subject. For example, the decision unit according to one embodiment of the invention may treat the height as the most important determinant among the height, weight, and body mass index, and treat the body mass index as the least important determinant.

Although the thresholds for the height, weight, and body mass index considered in determining the type of inter-electrode distance applied to the subject have been described above by way of illustration, it is noted that the configuration according to the invention is not necessarily limited to the foregoing but may be changed without limitation as long as the objects of the invention may be achieved.

Further, the decision unit according to one embodiment of the invention may decide whether the distance between the two or more electrodes included in the electrode unit 1420 coupled to the main body unit 1410 corresponds to the inter-electrode distance determined to be applied to the subject.

Next, the provision unit according to one embodiment of the invention may generate feedback information on whether the distance between the two or more electrodes included in the electrode unit 1420 corresponds to the inter-electrode distance for the subject, according to a result of the decision of the decision unit. Specifically, if the distance between the two or more electrodes included in the electrode unit 1420 coupled to the main body unit 1410 does not correspond to the inter-electrode distance applied to the subject, the provision unit according to one embodiment of the invention may generate feedback information to be provided to the subject or administrator to inform that the electrode unit 1420 with an inter-electrode distance unsuitable for the subject is coupled to the main body unit 1410. For example, if the subject's height is less than the minimum threshold so that the electrode unit 1420 with the minimum inter-electrode distance is suitable for the subject, but the electrode unit 1420 with the maximum inter-electrode distance is coupled to the main body unit 1410, the provision unit according to one embodiment of the invention may generate feedback information to the effect that the inter-electrode distance of the electrode unit 1420 is not suitable for the subject. Accordingly, the subject or administrator will be able to ensure that the electrode unit 1420 with an inter-electrode distance suitable for the subject is coupled to the main body unit 1410 on the basis of the feedback information.

Therefore, the subject may wear the biosignal measurement device provided with the electrode unit 1420 having an inter-electrode distance suitable for physical condition of the subject.

Next, the communication unit according to one embodiment of the invention may function to enable data transmission/reception from/to the acquisition unit, the decision unit, and the provision unit.

Lastly, the control unit according to one embodiment of the invention may function to control data flow among the acquisition unit, the decision unit, the provision unit, and the communication unit. That is, the control unit according to one embodiment of the invention may control data flow into/out of the main body unit 1410 or data flow among the respective components of the main body unit 1410, such that the acquisition unit, the decision unit, the provision unit, and the communication unit may carry out their particular functions, respectively.

The embodiments according to the invention as described above may be implemented in the form of program instructions that can be executed by various computer components, and may be stored on a computer-readable recording medium. The computer-readable recording medium may include program instructions, data files, and data structures, separately or in combination. The program instructions stored on the computer-readable recording medium may be specially designed and configured for the present invention, or may also be known and available to those skilled in the computer software field. Examples of the computer-readable recording medium include the following: magnetic media such as hard disks, floppy disks and magnetic tapes; optical media such as compact disk-read only memory (CD-ROM) and digital versatile disks (DVDs); magneto-optical media such as floptical disks; and hardware devices such as read-only memory (ROM), random access memory (RAM) and flash memory, which are specially configured to store and execute program instructions. Examples of the program instructions include not only machine language codes created by a compiler, but also high-level language codes that can be executed by a computer using an interpreter. The above hardware devices may be changed to one or more software modules to perform the processes of the present invention, and vice versa.

Although the present invention has been described above in terms of specific items such as detailed elements as well as the limited embodiments and the drawings, they are only provided to help more general understanding of the invention, and the present invention is not limited to the above embodiments. It will be appreciated by those skilled in the art to which the present invention pertains that various modifications and changes may be made from the above description.

Therefore, the spirit of the present invention shall not be limited to the above-described embodiments, and the entire scope of the appended claims and their equivalents will fall within the scope and spirit of the invention.

What is claimed is:

1. A method for remote monitoring of biosignals, the method comprising the steps of:
transmitting unique information of a first biosignal measurement device to a server;
receiving an activation command for at least a part of functions of the first biosignal measurement device, in response to matching between the unique information of the first biosignal measurement device and unique information of a first subject received from the server; and
generating a symmetric key for the first biosignal measurement device on the basis of a public key generated by the first biosignal measurement device and a public key generated by the server, and encrypting biosignal data measured by the first biosignal measurement device using the generated symmetric key.

2. A non-transitory computer-readable recording medium having stored thereon a computer program for executing the method of claim 1.

3. A method for remote monitoring of biosignals, the method comprising the steps of:
transmitting unique information of a first subject to a first biosignal measurement device;
receiving information on matching between unique information of the first biosignal measurement device and the unique information of the first subject; and
generating a symmetric key for the first biosignal measurement device on the basis of a public key generated by the first biosignal measurement device and a public key generated by the server, and decrypting biosignal data received from the first biosignal measurement device using the generated symmetric key.

4. A non-transitory computer-readable recording medium having stored thereon a computer program for executing the method of claim 3.

5. A device for remote monitoring of biosignals, the device comprising:
a communication unit configured to transmit unique information of a first biosignal measurement device to a server, and receive an activation command for at least a part of functions of the first biosignal measurement device, in response to matching between the unique information of the first biosignal measurement device and unique information of a first subject received from the server; and
a control unit configured to generate a symmetric key for the first biosignal measurement device on the basis of a public key generated by the first biosignal measurement device and a public key generated by the server, and encrypt biosignal data measured by the first biosignal measurement device using the generated symmetric key.

6. A server for remote monitoring of biosignals, the server comprising:
a communication unit configured to transmit unique information of a first subject to a first biosignal measurement device, and receive information on matching between unique information of the first biosignal measurement device and the unique information of the first subject; and
a control unit configured to generate a symmetric key for the first biosignal measurement device on the basis of a public key generated by the first biosignal measurement device and a public key generated by the server, and decrypt biosignal data received from the first biosignal measurement device using the generated symmetric key.
